(19) United States
(12) Patent Application Publication
(10) Pub. No.: US 2018/0251108 A1
(43) Pub. Date: Sep. 6, 2018

(54) Electromagnetic Valve, Fluid Pressure Control Device, and Brake Apparatus

(71) Applicant: HITACHI AUTOMOTIVE SYSTEMS, LTD., Hitachinaka-shi, Ibaraki (JP)

(72) Inventors: Takahiro YAMAGUCHI, Hamura-shi, Tokyo (JP); Chiharu NAKAZAWA, Kawasaki-shi, Kanagawa (JP)

(21) Appl. No.: 15/758,160

(22) PCT Filed: Aug. 17, 2016
(86) PCT No.: PCT/JP2016/073955

§ 371 Date: Mar. 7, 2018

(30) Foreign Application Priority Data
Sep. 8, 2015 (JP) 2015-176636

(51) Int. Cl. B60T 8/36; F16K 31/06; F16K 51/00

(52) U.S. Cl. CPC B60T 8/368; B60T 8/3645; B60T 8/367; F16K 51/00; F16K 31/0693; F16K 31/0665

(57) ABSTRACT

Provided are an electromagnetic valve capable of suppressing an increase in size in an axial direction thereof, a fluid pressure control device, and a brake apparatus. A first filter member configured to filter a fluid is provided in a flow path between a valve seat and a second communication bore.

### TECHNICAL FIELD

The present invention relates to an electromagnetic valve, a fluid pressure control device, and a brake apparatus.

### BACKGROUND ART

Patent Literature 1 discloses an electromagnetic valve including a filter provided at an axial end portion thereof to filter a fluid.

### CITATION LIST

### Patent Literature

PTL 1: Japanese Unexamined Patent Application Publication No. 2014-211237

### SUMMARY OF INVENTION

### Technical Problem

The above-described conventional technique, however, suffers from the problem that the electromagnetic valve is increased in size in the axial direction.

An object of the present invention is to provide an electromagnetic valve capable of suppressing an increase in size in an axial direction thereof, a fluid pressure control device, and a brake apparatus.

### Solution to Problem

In one embodiment of the present invention, a first filter member filtering a fluid is provided in a flow path between a valve seat and a second communication bore.

Thus, the first filter member is provided in the flow path; therefore, it is possible to suppress an increase in size in the axial direction.

### BRIEF DESCRIPTION OF DRAWINGS

FIG. 1 is a schematic structural diagram of a brake apparatus according to a first embodiment.

FIG. 2 is a perspective view of a part of the brake apparatus according to the first embodiment.

FIG. 3 is a rear transparent view of a housing of a second unit in the first embodiment.

FIG. 4 is a right side view of the second unit as seen through the housing in the first embodiment.

FIG. 5 is a longitudinal sectional view of a shut-off valve 21.

FIG. 6 is an exploded perspective view of the shut-off valve 21.

FIG. 7 is an illustration showing the shape of a first filter member 21-8.

FIG. 8 is a longitudinal sectional view of an SOL/V IN 22.

FIG. 9 is an exploded perspective view of the SOL/V IN 22.

FIG. 10 is a longitudinal sectional view of a communication valve 23.

FIG. 11 is an exploded perspective view of the communication valve 23.

FIG. 12 is a longitudinal sectional view of an SS/V IN 27.

FIG. 13 is an exploded perspective view of the SS/V IN 27.

FIG. 14 is a longitudinal sectional view of a shut-off valve 21 in another embodiment.

FIG. 15 is a longitudinal sectional view of a shut-off valve 21 in another embodiment.

FIG. 16 is a longitudinal sectional view of an SS/V IN 27 in another embodiment.

FIG. 17 is a longitudinal sectional view of an SS/V IN 27 in another embodiment.

### DESCRIPTION OF EMBODIMENTS

### First Embodiment

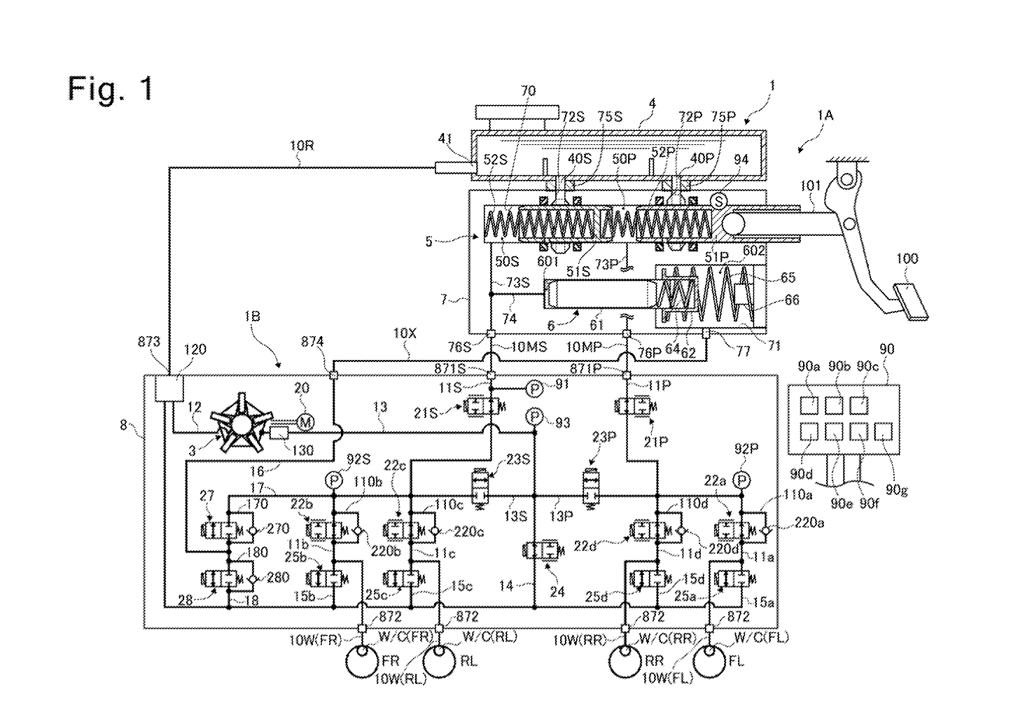

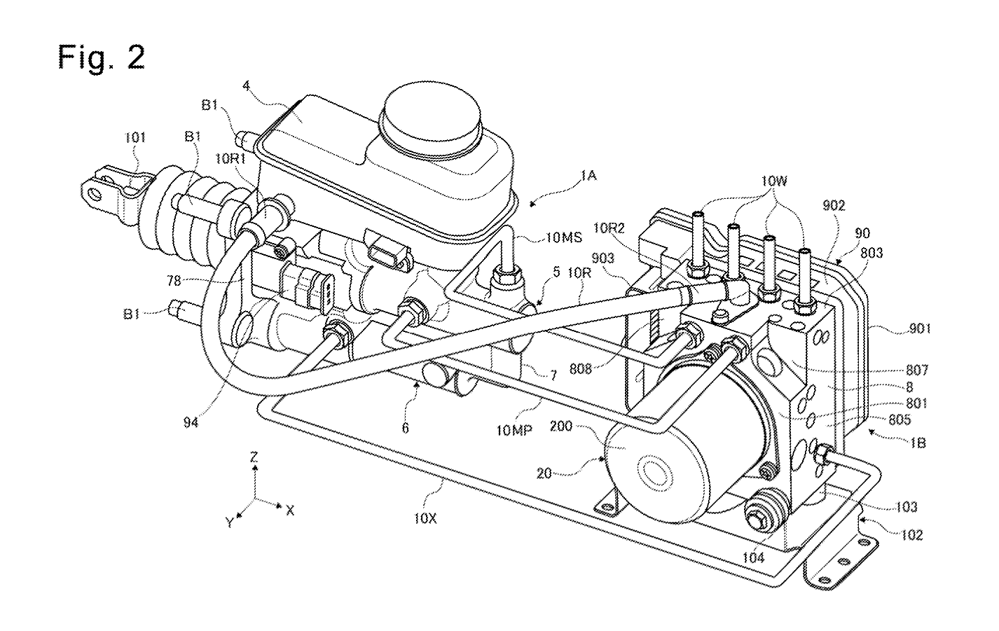

FIG. 1 is a schematic structural diagram of a brake apparatus according to a first embodiment. FIG. 2 is a perspective view of a part of the brake apparatus according to the first embodiment.

The brake apparatus 1 is applied to electric vehicles. Examples of electric vehicles include hybrid vehicles including a motor generator in addition to an engine, and electric automobiles including only a motor generator, as prime movers for driving wheels. Electric vehicles can perform regenerative braking in which a vehicle's kinetic energy is regenerated into electrical energy by a regenerative braking device including a motor generator, thereby braking the vehicle. The brake apparatus 1 is a fluid pressure braking apparatus that applies a frictional braking force produced by the pressure of fluid to each of wheels FL to RR of the vehicle. The wheels FL to RR are each provided with a brake actuating unit. The brake actuating unit is a fluid pressure-generating unit including a wheel cylinder W/C. The brake actuating unit is of a disk type, for example, which includes a caliper (hydraulic brake caliper). The caliper includes a brake disk and a brake pad. The brake disk is a brake rotor rotatable together with a tire. The brake pad is disposed with a predetermined clearance with respect to the brake disk and moved to contact the brake disk by the fluid pressure in the wheel cylinder W/C. This produces a frictional braking force. The brake apparatus 1 includes brake lines of two systems (primary P system and secondary S system). The brake line arrangement is an X-split brake line arrangement, for example. It should be noted that another brake line arrangement may be adopted, e.g. a front-rear split brake line arrangement. Hereinafter, to distinguish between members provided in association with the P system and members provided in association with the S system, the letters P and S will be added to the ends of the reference signs of the P and S system members, respectively. The brake apparatus 1 supplies a brake fluid as a working fluid (hydraulic oil) to each brake actuating unit through the brake lines to generate a fluid pressure (brake fluid pressure) in the wheel cylinder W/C. In this way, a fluid pressure braking force is applied to each of the wheels FL to RR.

The brake apparatus 1 includes a first unit 1A and a second unit 1B. The first unit 1A and the second unit 1B are installed in a motor chamber isolated from the driver's seat of the vehicle and are connected to each other through a plurality of lines. The plurality of lines include a master cylinder line 10M (primary line 10MP and secondary line 10MS), a wheel cylinder line 10W, a back-pressure line 10X, and a suction line 10R. The lines 10M, 10W, and 10X, excluding the suction line 10R, are metallic brake pipes (metal lines), and specifically, steel pipes such as double-walled steel pipes. The lines 10M, 10W, and 10X each include rectilinear portions and bent portions and change their course at the bent portions, thereby being disposed between the associated ports. The lines 10M, 10W, and 10X each include flared male pipe joints at both ends thereof. The suction line 10R is a brake hose (hose line) formed to be flexible by using a material such as rubber. The ends of the suction line 10R are connected to a port 873 and the like through nipples 10R1 and 10R2, respectively. The nipples 10R1 and 10R2 are connecting members made of a resin, each including a tubular portion.

A brake pedal 100 is a brake operating member receiving a brake operation input by the driver. A push rod 101 is pivotably connected to the brake pedal 100. The first unit 1A is a brake operating unit mechanically connected to the brake pedal 100 and is also a master cylinder unit including a master cylinder 5. The first unit 1A includes a reservoir tank 4, a housing 7, a master cylinder 5, a stroke sensor 94, and a stroke simulator 6. The reservoir tank 4 is a brake fluid source storing a brake fluid and is a low-pressure section open to the atmospheric pressure. The reservoir tank 4 is provided with a replenishment port 40 and a supply port 41. The suction line 10R is connected to the supply port 41. The housing 7 is a casing in which the master cylinder 5 and the stroke simulator are accommodated (built). In the housing 7, a cylinder 70 for the master cylinder 5, a cylinder 71 for the stroke simulator 6, and a plurality of oil passages (fluid passages) are formed. The plurality of oil passages include a replenishment oil passage 72, a supply oil passage 73, and a positive-pressure oil passage 74. The housing 7 has a plurality of ports formed therein. These ports are open on the outer surface of the housing 7. The plurality of ports include replenishment ports 75P and 75S, a supply port 76, and a back-pressure port 77. The replenishment ports 75P and 75S are connected to replenishment ports 40P and 40S, respectively, of the reservoir tank 4. The master cylinder line 10M is connected to the supply port 76, and the back-pressure line 10X is connected to the back-pressure port 77. The replenishment oil passage 72 is connected at one end thereof to the replenishment port 75 and at the other end thereof to the cylinder 70.

The master cylinder 5 is a first fluid pressure source capable of supplying a working fluid pressure to each wheel cylinder W/C. The master cylinder 5 is connected to the brake pedal 100 through the push rod 101 to operate in response to a driver's operation on the brake pedal 100. The master cylinder 5 includes a piston 51 movable in an axial direction in response to an operation on the brake pedal 100. The piston 51 is accommodated in the cylinder 70 to define a fluid pressure chamber 50. The master cylinder 5 is a tandem master cylinder which includes, as the piston 51, a primary piston 51P connected to the push rod 101 and a free piston-type secondary piston 51S connected in series to the primary piston 51P. The pistons 51P and 51S define a primary chamber 50P, and the secondary piston 51S defines a secondary chamber 50S. The supply oil passage 73 is connected at one end thereof to the fluid pressure chamber 50 and at the other end thereof to the supply port 76. The fluid pressure chambers 50P and 50S are replenished with the brake fluid from the reservoir tank 4 and generate a fluid pressure (master cylinder fluid pressure) in response to the movement of the piston 51. In the primary chamber 50P, a coil spring 52P as a return spring is interposed between the pistons 51P and 51S. In the secondary chamber 50S, a coil spring 52S as a return spring is interposed between the bottom of the cylinder 70 and the piston 51S. The stroke sensor 94 detects a stroke (pedal stroke) of the primary piston 51P. The primary piston 51P is provided with a magnet for detection, and the sensor body is attached to the outer surface of the housing 7 of the first unit 1A.

The stroke simulator 6 operates in response to a driver's braking operation to apply a reaction force and a stroke to the brake pedal 100. The stroke simulator 6 includes a piston 61, a positive-pressure chamber 601 and a back-pressure chamber 602 which are defined by the piston 61, and a resilient body (first spring 64, second spring 65, and damper 66) biasing the piston 61 in a direction in which the volumetric capacity of the positive-pressure chamber 601 decreases. Between the first spring 64 and the second spring 65 is interposed a bottomed circular cylinder-shaped retainer member 62. The positive-pressure oil passage 74 is connected at one end thereof to a secondary-side supply oil passage 73S and at the other end thereof to the positive-pressure chamber 601. When the brake fluid flows into the positive-pressure chamber 601 from the master cylinder 5 (secondary chamber 50S) in response to a driver's braking operation, a pedal stroke is generated, and reaction force against a driver's braking operation is produced by the biasing force of the resilient body. It should be noted that the first unit 1A does not include an engine vacuum booster that boosts the brake operating force by using an intake negative pressure generated by the vehicle engine.

The second unit 1B is a fluid pressure control device provided between the first unit 1A and the brake actuating units. The second unit 1B is connected to the primary chamber 50P through the primary line 10MP and connected to the secondary chamber 50S through the secondary line 10MS. Further, the second unit 1B is connected to the wheel cylinders W/C through the wheel cylinder lines 10W, respectively, and connected to the back-pressure chamber 602 through the back-pressure line 10X. Further, the second unit 1B is connected to the reservoir tank 4 through the suction line 10R. The second unit 1B includes a housing 8, a motor 20, a pump 3, a plurality of electromagnetic valves 21, etc., a plurality of fluid pressure sensors 91, etc., and an electronic control unit 90 (hereinafter referred to as “an ECU”). The housing 8 is a casing for accommodating (building) therein the pump 3 and the valves, such as the electromagnetic valves 21. In the housing 8, the circuits (brake fluid pressure circuits) of the above-described two systems (P system and S system) through which the brake fluid flows are formed by a plurality of oil passages. The plurality of oil passages include a supply oil passage 11, a suction oil passage 12, a discharge oil passage 13, a pressure-regulating oil passage 14, a pressure-reducing oil passage 15, a back-pressure oil passage 16, a first simulator oil passage 17, and a second simulator oil passage 18. Further, in the housing 8, a reservoir (internal reservoir) 120, which is a fluid storage, and a damper 130 are formed. The housing 8 includes a plurality of ports formed therein, and these ports are open on the outer surface of the housing 8. The plurality of ports include master cylinder ports 871 (primary port 871P and secondary port 871S), a suction port 873, a back-pressure port 874, and wheel cylinder ports 872. The primary line 10MP and the secondary line 10MS are attached and connected to the primary port 871P and the secondary port 871S, respectively. The suction line 10R is attached and connected to the suction port 873. The back-pressure line 10X is attached and connected to back-pressure port 874. The wheel cylinder lines 10W are attached and connected to the wheel cylinder ports 872, respectively.

The motor 20 is a rotary electric motor and includes a rotating shaft for driving the pump 3. The motor 20 may be a brushless motor or may be a brushed motor. The motor 20 includes a resolver detecting the rotational angle of the rotating shaft. The resolver functions as a rotational speed sensor detecting the rotational speed of the motor 20. The pump 3 is a fluid pressure source capable of supplying a working fluid pressure to the wheel cylinders W/C and includes five pump sections driven by one motor 20. The pump 3 is for common use by the S system and the P system. The electromagnetic valves 21, etc. are solenoid valves each operating in response to a control signal such that a valve element strokes in response to the supply of electric current to a solenoid to switch between opening and closing an oil passage (between connecting and disconnecting the oil passage). The electromagnetic valves 21, etc. generate a control fluid pressure by controlling the communication state of the above-described circuits to thereby adjust the flow state of the brake fluid. The plurality of electromagnetic valves 21, etc. include a shut-off valve 21, a pressure-increasing valve (hereinafter referred to as “an SOL/V IN”) 22, a communication valve 23, a pressure-regulating valve 24, a pressure-reducing valve (hereinafter referred to as “an SOL/V OUT”) 25, a stroke simulator IN valve (hereinafter referred to as “an SS/V IN”) 27, and a stroke simulator OUT valve (hereinafter referred to as “an SS/V OUT”) 28. The shut-off valve 21, the SOL/V IN 22, and the pressure-regulating valve 24 are normally-open electromagnetic valves which are open when not energized. The communication valve 23, the pressure-reducing valve 25, the SS/V IN 27, and the SS/V OUT 28 are normally-closed electromagnetic valves which are closed when not energized. The shut-off valve 21, the SOL/V IN 22, and the pressure-regulating valve 24 are proportional control valves whose degree of opening is adjusted according to the electric current supplied to their solenoids. The communication valve 23, the pressure-reducing valve 25, the SS/V IN 27, and the SS/V OUT 28 are on-off valves controlled in a binary manner to switch between opening and closing. It should be noted that proportional control valves may be used as these valves. The fluid pressure sensors 91, etc. detect the discharge pressure of the pump 3 and the master cylinder fluid pressure. The plurality of fluid pressure sensors include a master cylinder fluid pressure sensor 91, a discharge pressure sensor 93, and a wheel cylinder fluid pressure sensor 92 (primary pressure sensor 92P and secondary pressure sensor 92S).

The brake fluid pressure circuit of the second unit 1B will be explained below on the basis of FIG. 1. The members associated with the wheels FL to RR are appropriately distinguished from each other by adding the letters a to d to the ends of the reference signs thereof. A supply oil passage 11P is connected at one end side thereof to a primary port 871P. The other end side of the supply oil passage 11P branches off into an oil passage 11a for the left front wheel and an oil passage 11d for the right rear wheel. The oil passages 11a and 11d are connected to the associated wheel cylinder ports 872, respectively. A supply oil passage 11S is connected at one end side thereof to a secondary port 871S. The other end side of the supply oil passage 11S branches off into an oil passage 11b for the right front wheel and an oil passage 11c for the left rear wheel. The oil passages 11b and 11c are connected to the associated wheel cylinder ports 872, respectively. The shut-off valve 21 is provided on the above-described one end side of the supply oil passages 11. On the above-described other end side of each of the oil passages 11, a SOL/V IN 22 is provided. A bypass oil passage 110 is provided in parallel to each oil passage 11 to bypass the SOL/V IN 22. Each bypass oil passage 110 is provided with a check valve 220. The check valves 220 allow only the flow of brake fluid from the wheel cylinder ports 872 toward the master cylinder ports 871.

The suction oil passage 12 connects the reservoir 120 and a suction port 823 of the pump 3. The discharge oil passage 13 is connected at one end side thereof to a discharge port 821 of the pump 3. The other end side of the discharge oil passage 13 branches off into an oil passage 13P for the P system and an oil passage 13S for the S system. The oil passages 13P and 13S are each connected to a section of the supply oil passage 11 between the shut-off valve 21 and the SOL/V IN 22. The discharge oil passage 13 is provided with a damper 130 on the above-described one end side thereof. The oil passages 13P and 13S on the above-described other end side are each provided with a communication valve 23. The oil passages 13P and 13S each function as a communication passage connecting the supply oil passage 11P of the P system and the supply oil passage 11S of the S system. The pump 3 is connected to the wheel cylinder ports 872 through the above-described communication passages (discharge oil passages 13P and 13S) and the supply oil passages 11P and 11S. The pressure-regulating oil passage 14 connects the reservoir 120 and a section of the discharge oil passage 13 between the damper 130 and the communication valves 23. The pressure-regulating oil passage 14 is provided with a pressure-regulating valve 24. The pressure-reducing oil passage 15 connects the reservoir 120 and a section of each of the oil passages 11a to 11d of the supply oil passage 11 between the SOL/V IN 22 and the associated wheel cylinder port 872. The pressure-reducing oil passage 15 is provided with an SOL/V OUT 25.

The back-pressure oil passage 16 is connected at one end side thereof to the back-pressure port 874. The other end side of the back-pressure oil passage 16 branches off into a first simulator oil passage 17 and a second simulator oil passage 18. The first simulator oil passage 17 is connected to a section of the supply oil passage 11S between the shut-off valve 21 and the SOL/V INs 22b and 22c. The first simulator oil passage 17 is provided with an SS/V IN 27. A bypass oil passage 170 is provided in parallel to the first simulator oil passage 17 to bypass the SS/V IN 27. The bypass oil passage 170 is provided with a check valve 270. The check valve 270 allows only the flow of brake fluid from the back-pressure oil passage 16 side toward the supply oil passage 11S. The second simulator oil passage 18 is connected to the reservoir 120. The second simulator oil passage 18 is provided with an SS/V OUT 28. A bypass oil passage 180 is provided in parallel to the second simulator oil passage 18 to bypass the SS/V OUT 28. The bypass oil passage 180 is provided with a check valve 280. The check valve 280 allows only the flow of brake fluid from the reservoir 120 side toward the back-pressure oil passage 16.

Between the shut-off valve 21 and the secondary port 871S in the supply oil passage 11S is provided a fluid pressure sensor 91 detecting the fluid pressure at this point (i.e. fluid pressure in the positive-pressure chamber 601 of the stroke simulator 6; master cylinder fluid pressure). Between the shut-off valve 21 and the SOL/V IN 22 in the supply oil passage 11 is provided a fluid pressure sensor 92 detecting the fluid pressure at this point (i.e. fluid pressure corresponding to the wheel cylinder fluid pressure). Between the damper 130 and the communication valve 23 in the discharge oil passage 13 is provided a fluid pressure sensor 93 detecting the fluid pressure at this point (i.e. pump discharge pressure).

Hereinafter, a three-dimensional orthogonal coordinate system having an X-axis, a Y-axis, and a Z-axis will be provided for convenience of explanation. In a state where the first unit 1A and the second unit 1B are installed in the vehicle, the Z-axis direction is a vertical direction, and the Z-axis positive direction is a vertically upward direction. The X-axis direction is a longitudinal direction of the vehicle, and the X-axis positive direction is a vehicle forward direction. The Y-axis direction is a lateral direction of the vehicle.

In the first unit 1A, the push rod 101 extends in the X-axis positive direction from an X-axis negative direction side end thereof that is connected to the brake pedal 100. The housing 7 is provided with a square plate-shaped flange portion 78 at an X-axis negative direction side end thereof. The flange portion 78 has bolt bores provided in the four corners thereof. Bolts B1 extend through the bolt bores to secure and mount the first unit 1A to a dash panel on the vehicle body side. The reservoir tank 4 is installed on the Z-axis positive direction side of the housing 7.

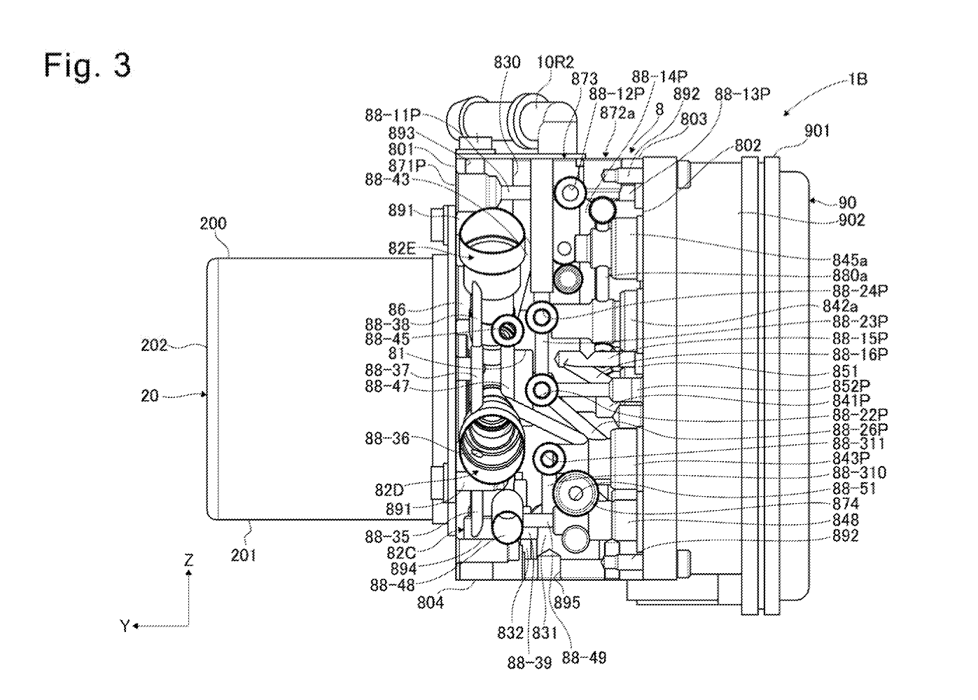

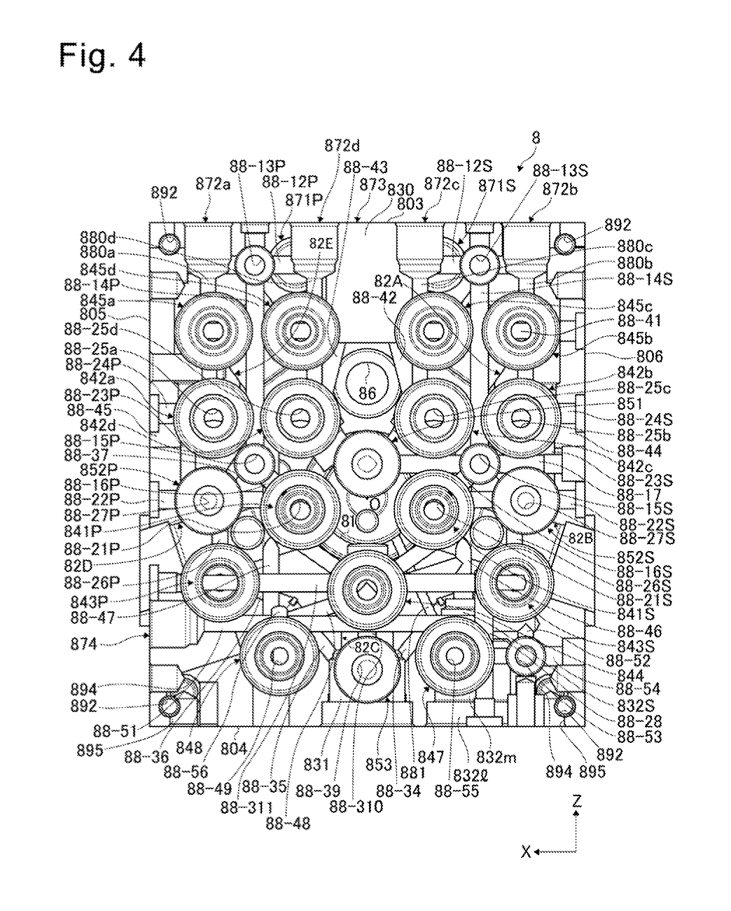

In the second unit 1B, the housing 8 is a generally rectangular parallelepiped-shaped block formed by using an aluminum alloy as a constituent material. The outer surface of the housing 8 includes a front surface 801, a rear surface 802, a top surface 803, a bottom surface 804, a right side surface 805, and a left side surface 806 (see FIGS. 3 and 4). The housing 8 has recesses 807 and 808 respectively formed at corners thereof on the front surface 801 side and the top surface 803 side. The housing 8 is secured to the vehicle body side (bottom surface of the motor chamber) through a mount 102. Insulators 103 and 104 are interposed between the housing 8 and the mount 102. On the front surface 801 of the housing 8, the motor 20 is disposed, and a motor housing 200 is mounted. The ECU 90 is mounted on the rear surface 802 of the housing 8. That is, the ECU 90 is integrally attached to the housing 8, The ECU 90 has a control board (not shown) and a control unit housing (casing) 901. The control board controls the state of energization of the motor 20 and the solenoids of the electromagnetic valves 21, etc. It should be noted that the control board may be equipped with various sensors detecting the motion state of the vehicle, e.g. an acceleration sensor detecting the acceleration of the vehicle, and an angular velocity sensor detecting the angular velocity (yaw rate) of the vehicle. It is also possible for the control board to be equipped with a composite sensor (combine sensor) having the above-mentioned sensors unitized into one component. The control board is housed in the casing 901. The casing 901 is a cover member fastened and secured to the rear surface 802 of the housing 8 with bolts.

The casing 901 is a cover member formed of a resin material and includes a control board housing part 902 and a connector part 903. The control board housing part 902 houses the control board and a part of the solenoids of the electromagnetic valves 21, etc. The connector part 903 is disposed closer to the X-axis positive direction side than the above-described terminals and electrically conductive member in the control board housing part 902 and protects in the Y-axis positive direction of the control board housing part 902. As viewed from the X-axis direction, the connector part 903 is disposed slightly outward (toward the X-axis positive direction side) relative to the left side surface 806 of the housing 8. The terminals of the connector part 903 are exposed toward the Y-axis positive direction and extend in the Y-axis negative direction so as to be connected to the control board. The terminals of the connector part 903 (which are exposed toward the Y-axis positive direction) are connectable to external equipment and the stroke sensor 94 (hereinafter referred to as “external equipment, etc.”). When another connector connected to the external equipment, etc. is inserted into the connector part 903 from the Y-axis positive direction side, electrical connection is made between the external equipment, etc. and the control board (ECU 90). In addition through the connector part 903, electric power is supplied ftom an external power supply (battery) to the control board. The electrically conductive member functions as a connecting part that electrically connects the control board and the motor 20 (stator thereof), so that electric power is supplied from the control board to the motor 20 (stator thereof) through the electrically conductive member.

FIGS. 3 and 4 are drawings showing passages, recesses, and bores as seen through the housing 8. FIG. 3 is a rear transparent view of the housig 8 as viewed from the Y-axis negative direction side, and FIG. 4 is a right side view of the second unit 1B as viewed from the X-axis positive direction side, showing the passages, etc. as seen through the housing 8.

The housing 8 includes a cam accommodating bore 81, a plurality of (five) cylinder accommodating bores 82A to 82E, a reservoir chamber 830, a damper chamber 831, a fluid storage chamber 832, a plurality of valve accommodating bores (installation bores) 84x (x=1 to 5, 7, 8), a plurality of sensor accommodating bores 85x (x=1 to 3), a power supply bore 86, a plurality of ports 87x (x=1 to 4), a plurality of oil passage bores 88x (x=−1y to −5y, 0, 1), and a plurality of bolt bores (pin bores) 89x (x=1 to 5). These bores and ports are formed with a drill or the like. The cam accommodating bore 81 is in the shape of a bottomed circular cylinder extending in the Y-axis direction. The cam accommodating bore 81 is open on the front surface 801. The cam accommodating bore 81 has an axial center O disposed approximately in the X-axis direction center of the front surface 801 and slightly closer to the Z-axis negative direction side than the center in the Z-axis direction.

The cylinder accommodating bores 82 are each in the shape of a stepped circular cylinder and extend in the radial direction of the cam accommodating bore 81 (radial directions centered on the axial center O). The cylinder accommodating bores 82 are spaced approximately equally (at approximately equal internals) in the circumferential direction about the axial center O. The angle made by the axial centers of each pair of cylinder accommodating bores 82 mutually adjacent in the circumferential direction about the axial center O is approximately 72° (within a predetermined range including 72°). The plurality of cylinder accommodating bores 82A to 82E are arranged in a single row along the Y-axis direction and disposed at the Y-axis positive direction side of the housing 8. The reservoir chamber 830 is in the shape of a bottomed circular cylinder having an axial center extending in the Z-axis direction. The reservoir chamber 830 is open on the top surface 803 at a position approximately in the X-axis direction center and in the Y-axis direction center. The reservoir chamber 830 is disposed in a region surrounded by the master cylinder port 871 and the wheel cylinder ports 872. The reservoir chamber 830 (bottom thereof at the Z-axis negative direction side) is disposed closer to the Z-axis positive direction side than the suction port 823 of each cylinder acccommodating bore 82. The reservoir chamber 830 is formed in a region between the cylinder accommodating bores 82A and 82E, which are mutually adjacent in the circumferential direction about the axial center O. The cylinder accommodating bores 82A to 82E and the reservoir chamber 830 partially overlap each other in the Y-axis direction (as viewed from X-axis direction). The damper chamber 831 is in the shape of a bottomed circular cylinder having an axial center extending in the Z-axis direction. The damper chamber 831 is open on the bottom surface 804 at a position approximately in the X-axis direction center and slightly closer to the Y-axis negative direction side than the Y-axis direction center. The damper chamber 831 is disposed closer to the Z-axis negative direction side than the cam accommodating bore 81. The fluid storage chamber 832 is in the shape of a stepped bottomed circular cylinder having an axis extending in the Z-axis direction. The fluid storage chamber 832 is open on the bottom surface 804 at a position closer to the X-axis negative direction side and to the Y-axis positive direction side. The fluid storage chamber 832 is disposed closer to the Z-axis negative direction side than the cam accommodaing bore 81. The fluid storage chamber 832 includes a large-diameter portion 832l at a side thereof closer to the bottom surface 804 (Z-axis negative direction side) and a small-diameter portion 832s at a side thereof remoter from the bottom surface 804 (Z-axis positive direction side). Further, the fluid storage chamber 832 includes a medium-diameter portion 832m between the large-diameter portion 832l and the small-diameter portion 832s.

The plurality of valve accommodating bores 84x are each in the shape of a stepped circular cylinder and extend in the Y-axis direction to open on the rear surface 802. The plurality of valve accommodating bores 84x each includes a large-diameter portion at a side thereof closer to the rear surface 802 (Y-axis negative direction side), a small-diameter portion at a side thereof remoter from the rear surface 802 (Y-axis positive direction side), and a medium-diameter portion between the large-diameter portion and the small-diameter portion. The plurality of valve accommodating bores 84x are arranged in a single row along the Y-axis direction and disposed at the Y-axis negative direction side of the housing 8. The cylinder accommodating bores 82 and the valve accommodating bores 84x line up along the Y-axis direction. As viewed from the Y-axis direction, the plurality of valve accommodating bores 84x overlap the cylinder accommodating bores 82 at least partially. Most part of the plurality of valve accommodating bores 84x fall within a circle formed by connecting the ends or the plurality of cylinder accommodating bores 82 that are closer to the large-diameter portion side thereof (side remoter from the axial center O). Alternatively, the outer periphery of the above-described circle and the valve accommodating bores 84x overlap each other at least partially.

The SOL/V OUT accommodating bores 845 each accommodate an SOL/V OUT 25. It should be noted that the bypass oil passage 1100 and the check valve 220 are formed of a cup-shaped seal member, etc. installed in the associated bore 842. The SOL/V OUT accommodating bores 845a to 845d line up in a row in the X-axis direction at the Z-axis positive direction side of the rear surface 802. The two SOL/V OUT accommodating bores of the P system are disposed at the X-axis positive direction side, and the two SOL/V OUT accommodating bores of the S system are disposed at the X-axis negative direction side. In the P system, the bore 845a is disposed closer to the X-axis positive direction side than the bore 845d; in the S system, the bore 845b is disposed closer to the X-axis negative direction side than the bore 845c. The SOL/V IN accommodating bores 842 each accommodate an SOL/V IN 22. The SOL/V IN accommodating bores 842a to 842d line up in a row in the X-axis direction at a position slighty closer to the Z-axis positive direction side than the axial center O (or the Z-axis direction center of the housing 8). The SOL/V IN accommodating bores 842 are adjacent to the SOL/V OUT accommodating bores 845 at the Z-axis negative direction side. The two SOL/V IN bores of the P system are disposed at the X-axis positive direction side, and the two SOL/V IN bores of the S system are disposed at the X-axis negative direction side. In the P system, the bore 842a is disposed closer to the X-axis positive direction side than the bore 842d; in the S system, the bore 842b is disposed closer to the X-axis negative direction side than the bore 842c. The bores 842a to 842d have their axial centers approximately at the same positions as those of the bores 845a to 845d in the X-axis direction.

The shut-off valve acc6ommodating bores 841 each accommodate a shut-off valve 21. The shut-off valve accommodating bores 841P and 841S line up in the X-axis direction at a position slightly closer to the Z-axis negative direction side than the Z-axis direction center of the housing 8. The bore 841P is disposed slightly closer to the X-axis positive direction side than the X-axis direction center, and the bore 841S is disposed slightly closer to the X-axis negative direction side than the X-axis direction center. The bores 841P and 841S have their axial centers slightly closer to the Z-axis negative direction side than the axial center O and approximately at the same positions as those of the bores 842d and 842c in the X-axis direction. The communication valve accommodating bores 843 each accommodate a communication valve 23. The communication valve accommodating bores 843P and 843S line up in the X-axis direction at a position closer to the Z-axis negative direction side than the axial center O. Ihe communication valve accommodating bores 843 are adjacent to the shut-off valve accommodating bores 841 at the Z-axis negative direction side. The bore 843P is disposed closer to the X-axis positive direction side than the X-axis direction center, and the bore 843S is disposed closer to the X-axis negative direction side than the X-axis direction center. The bore 843P has an axial center slightly closer to the X-axis negative direction side than that of the bore 842a, and the bore 843S has an axial center slightly closer to the X-axis positive direction side than that of the bore 842b. On the rear surface 802, the Z-axis positive direction ends of the openings of the communication valve accommodating bores 843 overlap the Z-axis negative direction ends of the openings of the shut-off valve accommodating bores 841 in the Z-axis direction (as viewed from the X-axis direction). The pressure-regulating valve accommodatimg bore 844 accommodates a pressure-regulating valve 24. The pressure-regulating valve accommodating bore 844 is disposed at a position closer to the Z-axis negative direction side than the axial center O and approximately the same position as the axial center O in the X-axis direction. The pressure-regulating valve accommodating bore 844 is disposed between the communication valve accommodating bores 843P and 843S and adjacent to the shut-off valve accommodating bores 841 at the Z-axis negative direction side. The pressure-regulating valve accommodating bore 844 is approximately at the same position as the communication valve accommodating bores 843 in the Z-axis direction and lines up in a row with the bores 843P and 843S in the X-axis direction. On the rear surface 802, both ends in the X-axis direction of the opening of the pressure-regulating valve accommodating bore 844 overlap the respective ends in the X-axis direction of the openings of the shut-off valve accommodating bores 841 in the X-axis direction (as viewed from the Z-axis direction).

The SS/V IN accommodating bore 847 accommodates an SS/V IN 27. It should be noted that the bypass oil passage 170 and the check valve 270 are formed of a cup-shaped seal member, etc. installed in the bore 847. The SS/V OUT accommodating bore 848 accommodates an SS/V OUT 28. It should be noted that the bypass oil passage 180 and the check valve 280 are formed of a cup-shaped seal member, etc. installed in the bore 848. The bores 847 and 848 line up in the X-axis direction at a position closer to the Z-axis negative direction side than the axial center O. The bores 847 and 848 are adjacent to the communication valve accommodating bores 843 and the pressure-regulating valve accommodating bore 844 at the Z-axis negative direction side. The bore 848 has an axial center between the axial center of the bore 844 and the axial center of the bore 843P in the X-axis direction and slightly closer to the X-axis positive direction side than the axial center of the bore 841P. On the rear surface 802, the end in the X-axis positive direction of the opening of the bore 848 overlaps the end in the X-axis negative direction of the bore 843P in the X-axis direction (as viewed from the Z-axis direction). The end in the Z-axis positive direction of the opening of the bore 848 overlaps the end in the Z-axis negative direction of the opening of the bore 843P in the Z-axis direction (as viewed from the Y-axis direction). The bore 847 has an axial center between the axial center of the bore 844 and the axial center of the bore 843S in the X-axis direction and slightly closer to the X-axis negative direction side than the axial center of the bore 841S. On the rear surface 802, the end in the X-axis negative direction of the opening of the bore 847 overlaps the end in the X-axis positive direction of the opening of the bore 843S in the X-axis direction (as viewed from the Z-axis direction). The end in the Z-axis positive direction of the opening of the bore 847 overlaps the end in the Z-axis negative direction of the opening of the bore 843S in the Z-axis direction (as viewed from the Y-axis direction).

The plurality of sensor accommodating bores 85x are each in the shape of a bottomed circular cylinder having an axial center extending in the Y-axis direction and open on the rear surface 802. The master cylinder fluid pressure sensor accommodating bore 851 accommodates a pressure-sensing part of a master cylinder fluid pressure sensor 91. The bore 851 is disposed approximately in the X-axis direction center and approximately in the Z-axis direction center of the housing 8. The bore 851 has an axial center slightly closer to the Z-axis positive direction side than the axial center O. The bore 851 is disposed in a region surrounded by the bores 842, 845, 841P, and 841S. The discharge pressure sensor accommodating bore 853 accommodates a pressure-sensing part of a discharge pressure sensor 93. The bore 853 is disposed approximately in the X-axis direction center of the housing 8 and closer to the Z-axis negative direction side. The bore 853 has an axial center slightly closer to the Z-axis negative direction side than the bores 847 and 848. The bore 853 is disposed in a region surrounded by the bores 844, 847, and 848. The wheel cylinder fluid pressure sensor accommodating bores 852 each accommodate a pressure-sensing part of a wheel cylinder fluid pressure sensor 92. The bores 852P and 852S line up in the X-axis direction approximately at the same position as the axial center O in the Z-axis direction. The bore 852P is disposed closer to the X-axis positive direction side than the X-axis direction center, and the bore 852S is disposed closer to the X-axis negative direction side than the X-axis direction center. The bore 852P has an axial center slightly closer to the X-axis positive direction side than the axial center of the bore 842a, and the bore 852S has an axial center slightly closer to the X-axis negative direction side than the axial center of the bore 842b. The bores 852 are each disposed in a region surrounded by the bores 841, 842, and 843. The power supply bore 86 is in the shape of a circular cylinder and extends through the housing 8 (between the front surface 801 and the rear surface 802) in the Y-axis direction. The power supply bore 86 is disposed approximately in the X-axis direction center of the housing 8 and closer to the Z-axis positive direction side. The power supply bore 86 is disposed in a region surrounded by the bores 842c and 842d, and the bores 845c and 845d, and is disposed between the mutually adjacent bores 82A and 82E.

The master cylinder ports 871 are each in the shape of a bottomed circular cylinder having an axial center extending in the Y-axis direction. The master cylinder ports 871 are open on the front surface 801 at a Z-axis positive direction-side end region lying between the recesses 807 and 808. The primary port 871P is disposed closer to the X-axis positive direction side, and the secondary port 871S is disposed closer to the X-axis negative direction side. The two ports 871P and 871S line up in the X-axis direction to face each other across the reservoir chamber 830 and a bolt bore 891 in the X-axis direction (as viewed from the Y-axis direction). The ports 871P and 871S lie between the reservoir chamber 830 and the cylinder accommodating bores 82A and 82E, respectively, in the circumferential direction about the axial center O (as viewed from the Y-axis direction). The openings of the master cylinder ports 871 and the openings of the bolt bores 891 partially overlap each other in the Z-axis direction (as viewed from the X-axis direction). The wheel cylinder ports 872 are each in the shape of a bottomed circular cylinder having an axial center extending in the Z-axis direction. The wheel cylinder ports 872 are open on the top surface 803 at a Y-axis negative direction-side position (closer to the rear surface 802 than to the front surface 801). The ports 872a to 872d line up in a row in the X-axis direction. The two ports 872 of the P system are disposed closer to the X-axis positive direction side, and the two ports 872 of the S system are disposed closer to the X-axis negative direction side. In the P system, the port 872a is disposed closer to the X-axis positive direction side than the port 872d. In the S system, the port 872b is disposed closer to the X-axis negative direction side than the port 872c. The ports 872c and 872d are disposed to face each other across the suction port 873 (reservoir chamber 830) as viewed from the Y-axis direction. The openings of the ports 872 and the suction port 873 (opening of the reservoir chamber 830) partially overlap each other in the X-axis direction (as viewed from the Y-axis direction). The openings of the ports 872 and the opening of the suction port 873 partially overlap each other in the Y-axis direction (as viewed from the X-axis direction).

The suction port 873 is an opening portion of the reservoir chamber 830 that is open on the top surface 803. The suction port 873 is formed to extend upward in the vertical direction and opens upward in the vertical direction. The port 873 is open on the top surface 803 at a position closer to the X-axis direction center and the Y-axis direction center and closer to the front surface 801 than the wheel cylinder ports 872. The port 873 is disposed closer to the Z-axis positive direction side than the suction ports 823 of the cylinder accommodating bores 82A to 82E. The cylinder accommodating bores 82A and 82E are disposed to face each other across the port 873 as viewed From the Y-axis direction. The openings of the cylinder accommodating bores 82A and 82E and the port 873 partially overlap each other in the Y-axis direction (as viewed from the X-axis direction). The back-pressure port 874 is in the shape of a bottomed circular cylinder having an axial center extending in the X-axis direction. The back-pressure port 874 is open on the right side surface 805 at a position slightly closer to the Y-axis negative direction side and closer to the Z-axis negative direction side than the axial center O. The back-pressure port 874 has an axial center between the axial centers of the communication valve accommodating bores 843 and the axial center of the SS/V OUT accommodating bore 848 in the Z-axis direction.

The plurality of oil passage bores 88x include first to fifth bore groups 88-1y to 88-5y and oil passage bores 880 and 881. The first bore group 88-1y connects the master cylinder ports 871, the shut-off valve accommodating bores 841, and the master cylinder fluid pressure sensor accommodating bore 851. The second bore group 88-2y connects the shut-off valve accommodating bores 841, the communication valve accommodating bores 843, the SOL/V IN accommodating bores 842, the SS/V IN accommodating bore 847, and the wheel cylinder fluid pressure sensor accommodating bores 852. The third bore group 88-3y connects the discharge ports 821 of the cylinder accommodating bores 82, the communication valve accommodating bores 843, the pressure-regulating valve accommodating bore 844, and the discharge pressure sensor accommodating bore 853. The fourth bore group 88-4y connects the reservoir chamber 830, the suction ports 823 of the cylinder accommodating bores 82, the SOL/V OUT accommodating bores 845, the SS/V OUT accommodating bore 848, and the pressure-regulating valve accommodating bore 844. The fifth bore group 88-5y connects the back-pressure port 874, the SS/V IN accommodating bore 847, and the SS/V OUT accommodating bore 848. The oil passage bores 880 connect the SOL/V IN accommodating bores 842 and the wheel cylinder ports 872. The oil passage bore 881 connects the cam accommodating bore 81 and the fluid storage chamber 832.

The first bore group 88-1y has first to seventh bores 88-11 to 88-17. First, the P system will be explained. The first bore 88-11P extends from the bottom of the primary port 871P in the Y-axis negative direction. The second bore 88-12P extends from the right side surface 805 in the X-axis negative direction to connect to the first bore 88-11P. The third bore 88-13P extends from the rear surface 802 in the Y-axis positive direction to connect to the second bore 88-12P. The fourth bore 88-14P extends from the Y-axis positive direction side of the third bore 88-13P in the Z-axis negative direction. The fifth bore 88-15P extends from the rear surface 802 in the Y-axis positive direction to connect to the fourth bore 88-14P. The sixth bore 88-16P extends from the Y-axis positive direction end of the fifth bore 88-15P in a direction toward the X-axis positive, Y-axis negative and Z-axis negative direction side to connect to the medium-diameter portion of the shut-off valve accommodating bore 841P. The seventh bore 88-17 extends from the left side surface 806 in the X-axis positive direction to connect to the fifth bore 88-15P and also to the master cylinder fluid pressure sensor accommodating bore 851. The S system is in symmetry with the P system with respect to the X-axis direction center of the housing 8 except that the S system has no seventh bore 88-17.

The second bore group 88-2y has first to seventh bores 88-21 to 88-27. First, the P system will be explained. The first bore 88-21P extends slightly from the bottom of the shut-off valve accommodating bore 841 in the Y-axis positive direction. The second bore 88-22P extends from the right side surface 805 in the X-axis negative direction to connect to the first bore 88-21P. The third bore 88-23P extends from the top surface 803 in the Z-axis negative direction to connect to the X-axis positive direction side of the second bore 88-22P. The fourth bore 88-24P extends from the right side surface 805 in the X-axis negative direction to connect to a halfway point of the third bore 88-23P. The fifth bores 88-25a and 88-25d extend slightly from the X-axis positive direction side of the fourth bore 88-24P to the Y-axis positive direction side to connect to the bottoms of the SOL/V IN accommodating bores 842a and 842d, respectively. The sixth bore 88-26P extends from a halfway point of the second bore 88-22P in a direction toward the Y-axis negative and Z-axis negative direction side to connect to the medium-diameter portion of the communication valve accommodating bore 843P. The seventh bore 88-27P extends from the bottom of the wheel cylinder fluid pressure sensor accommodating bore 852P in the Y-axis positive direction to connect to a halfway point of the second bore 88-22P. The S system is in symmetry with the P system with respect to the X-axis direction center of the housing 8 except that the S system has an eighth bore 88-28. The eighth bore 88-28 extends from the X-axis negative direction side of the bottom surface 804 toward the Z-axis positive direction side to connect to the medium-diameter portion of the SS/V IN accommodating bore 847 and also to the medium-diameter portion of the communication valve accommodating bore 843S.

The third bore group 88-3y has first to twelfth bores 88-31 to 88-312. The first bore 88-31 extends from the discharge port 821 of the cylinder accommodating bore 82A in the Z-axis negative direction. The second bore 88-32 extends from the end of the first bore 88-31 in a direction toward the X-axis negative and Z-axis negative direction side to connect to the discharge port 821 of the cylinder accommodating bore 82B. The third bore 88-33 extends from the discharge port 821 of the cylinder accommodating bore 82B in a direction toward the X-axis positive and Z-axis negative direction side. The fourth bore 88-34 extends from the end of the third bore 88-33 in a direction toward the X-axis positive and Z-axis negative direction side to connect to the discharge port 821 of the cylinder accommodating bore 82C. The fifth bore 88-35 extends from the discharge port 821 of the cylinder accommodating bore 82C in a direction toward the X-axis positive and Z-axis positive direction side. The sixth bore 88-36 extends from the end of the fifth bore 88-35 in a direction toward the X-axis positive and Z-axis positive direction side to connect to the discharge port 821 of the cylinder accommodating bore 82D. The seventh bore 88-37 extends from the discharge port 821 of the cylinder accommodating bore 82D in a direction toward the X-axis negative and Z-axis positive direction side. The eighth bore 88-38 extends from the end of the seventh bore 88-37 in the Z-axis positive direction to connect to the discharge port 821 of the cylinder accommodating bore 82E. The ninth bore 88-39 extends from the bottom of the discharge pressure sensor accommodating bore 853 in the Y-axis positive direction to connect to the damper chamber 831 and also to the discharge port 821 of the cylinder accommodating bore 82C. The tenth bore 88-310 extends from the bottom of the damper chamber 831 in the Z-axis positive direction. The eleventh bore 88-311 extends from the right side surface 805 in the X-axis negative direction to connect to the bottoms of both the communication valve accommodating bores 843 and also to the end of the tenth bore 88-310. The twelfth bore 88-312 (not shown) extends slightly from the bottom of the pressure-regulating valve accommodating bore 844 in the Y-axis positive direction to connect to the eleventh bore 88-311.

The fourth bore group 88-4y has first to ninth bores 88-41 to 88-49. The first bore 88-41 extends from the left side surface 806 in the X-axis positive direction to connect to the bottom of the reservoir chamber 830 and also to the bottoms of the SOL/V OUT accommodating bores 845. The second bore 88-42 extends from the bottom of the reservoir chamber 830 in a direction toward the X-axis positive, Y-axis positive and Z-axis negative direction side to connect to the suction port 823 of the cylinder accommodating bore 82A. The third bore 88-43 extends from the bottom of the reservoir chamber 830 in a direction toward the X-axis positive, Y-axis positive and Z-axis negative direction side to connect to the suction port 823 of the cylinder accommodating bore 82E. The fourth bore 88-44 extends from the left side surface 806 in the X-axis positive direction to connect to the suction port 823 of the cylinder accommodating bore 82A. The fifth bore 88-45 extends from the right side surface 805 in the X-axis negative direction to connect to the suction port 823 of the cylinder accommodating bore 82E. The sixth bore 88-46 extends from the bottom of the fluid storage chamber 832 in the Z-axis positive direction to connect to the suction port 823 of the cylinder accommodating bore 82B and also to a halfway point of the fourth bore 88-44. The seventh bore 88-47 extends from the bottom surface 804 in the Z-axis positive direction to connect to the suction port 823 of the cylinder accommodating bore 82D and also to a halfway point of the fifth bore 88-45. The eighth bore 88-48 extends from the right side surface 805 in a direction toward the X-axis negative and Z-axis positive direction side to connect to the suction port 823 of the cylinder accommodating bore 82C and also to respective halfway points of the sixth and seventh bores 88-46 and 88-47. The ninth bore 88-49 extends from the bottom of the SS/V OUT accommodating bore 848 in the Y-axis positive direction to connect to a halfway point of the seventh bore 88-47.

The fifth bore group 88-5y has first to sixth bores 88-51 to 88-56. The first bore 88-51 extends from the bottom of the back-pressure port 874 in the X-axis negative direction. The second bore 88-52 extends from the end of the first bore 88-51 in the Z-axis negative direction. The third bore 88-53 extends from the rear surface 802 in the Y-axis positive direction. The third bore 88-53 connects to the second bore 88-52 on its way. The fourth bore 88-54 extends from the left side surface 806 in the X-axis positive direction. The end of the third bore 88-53 connects to a halfway point of the fourth bore 88-54. The fifth bore 88-55 extends slightly from the end of the fourth bore 88-54 in the Y-axis negative direction to connect to the bottom of the SS/V IN accommodating bore 847. The sixth bore 88-56 extends slightly from a halfway point of the first bore 88-51 in a direction toward the Y-axis negative and Z-axis negative direction side to connect to the medium-diameter portion of the SS/V OUT accommodating bore 848. The bores 880 extend from the bottoms of the wheel cylinder ports 872, respectively, in the Z-axis negative direction to connect to the medium-diameter portions of the SOL/V OUT accomodating bores 845 and also to the medium-diameter portions of the SOL/V IN accommodating bores 842, respectively. The bore 881 extends from the cam accommodating bore 81 in a direction toward the X-axis negative and Z-axis negative direction side to connect to the medium-diameter portion 832m of the fluid storage chamber 832.

The first to sixth bores 88-11 to 88-16P of the first bore group 88-1y connect the master cylinder ports 871 and the shut-off valve accommodating bores 841 to function as a part of the supply oil passage 11. The first to fifth bores 88-21 to 88-25 of the second bore group 88-2y connect the shut-off valve accommodating bores 841 and the SOL/V IN accommodating bores 842 to function as a part of the supply oil passage 11. The sixth bore 88-26P connects the communication valve accommodating bore 843 and the second bore 88-22P to function as a part of the discharge oil passage 13. The eighth bore 88-28 connects the SS/V IN accommodating bore 847 and the communication valve accommodating bore 843S to function as a part of the first simulator oil passage 17. The bores 880 connect the SOL/V IN accommodating bores 842 and the wheel cylinder ports 872 to function as a part of the supply oil passage 11. Further, the bores 880 connect the SOL/V IN accommodating bores 842 and the SOL/V OUT accommodating bores 845 to function as a part of the pressure-reducing oil passage 15. The first to eleventh bores 88-31 to 88-311 of the third bore group 88-3y connect the discharge ports 821 of the cylinder accommodating bores 82 and the communication valve accommodating bores 843 to function as a part of the discharge oil passage 13. The twelfth bore 88-312 connects the eleventh bore 88-311 and the pressure-regulating valve accommodating bore 844 to function as a part of the pressure-regulating oil passage 14. The first bore 88-41 of the fourth bore group 88-4y connects the SOL/V OUT accommodating bores 845 and the reservoir chamber 830 to function as a part of the pressure-reducing oil passage 15. The second to eighth bores 88-42 to 88-48 connect the reservoir chamber 830 and the suction ports 823 of the cylinder accommodating bores 82 to function as the suction oil passage 12. The ninth bore 88-49 connects the SS/V OUT accommodating bore 848 and the seventh bore 88-47 to function as the second simulator oil passage 18. The first to fifth bores 88-51 to 88-55 of the fifth bore group 88-5y connect the back-pressure port 874 and the SS/V IN accomodating bore 847 to function as the back-pressure oil passage 16 and as a part of the first simulator oil passage 17. The sixth bore 88-56 connects the first bore 88-51 and the SS/V OUT accommodating bore 848 to function as a part of the second simulator oil passage 18. The bore 881 connects the cam accommodating bore 81 and the fluid storage chamber 832 to function as a drain oil passage.

The plurality of bolt bores 89x include bolt bores 891 to 895. The bolt bores 891 are each in the shape of a bottomed circular cylinder having an axial center extending in the Y-axis direction. The bolt bores 891 are open on the front surface 801. There are three bores 891 provided approximately in symmetry with each other with respect to the axial center O of the cam accommodating bore 81. The distances from the axial center O to the bolt bores 891 are approximately equal to each other. One bore 891 is disposed approximately in the X-axis direction center of the front surface 801 (position coincident with the axial center O in the X-axis direction) and closer to the Z-axis positive direction side than the axial center O. The bore 891 is located between the master cylinder ports 871P and 871S in the X-axis direction and overlaps the reservoir chamber 830 as viewed from the Y-axis direction. The other two bores 891 are located at respective positions facing each other across the axial center O in the X-axis direction and closer to the Z-axis negative direction side than the axial center O. The bolt bores 892 are each in the shape of a bottomed circular cylinder having an axial center extending in the Y-axis direction. The bolt bores 892 are open on the rear surface 802. There are a total of four bolt bores 892 provided in the four corners, respectively, of the rear surface 802. The bolt bore 893 is in the shape of a bottomed circular cylinder having an axial center extending in the Z-axis direction. The bolt bore 893 is open on the top surface 803. There is one bolt bore 893 provided approximately in the X-axis direction center of the top surface 803 (position coincident with the axial center O in the X-axis direction) and closer to the Y-axis positive direction side. The bolt bores 894 are each in the shape of a bottomed circular cylinder having an axial center extending in the Y-axis direction. The bolt bores 894 are open on the front surface 801. There are two bores 894 provided in the front surface 801 at respective positions closer to the Z-axis negative direction side than the axial center O and at the opposite ends of the front surface 801 in the X-axis direction. The bores 894 are located opposite to the master cylinder ports 871 across the axial center O. The X-axis negative direction-side bore 894 is located approximately opposite to the primary port 871P across the axial center O. The X-axis positive direction-side bore 894 is located approximately opposite to the secondary port 871S across the axial center O. The bores 894 have respective axial centers disposed closer to the Z-axis negative direction side than the axial center of the Z-axis negative direction-side bolt bore 891 and closer to the side surfaces 805 and 806 (outer sides), respectively, in the X-axis direction. The bolt bores 895 are each in the shape of a bottomed circular cylinder having an axial center extending in the Z-axis direction. There are two bolt bores 895 provided to open on the bottom surface 804 at respective positions approximately in the Y-axis direction center and at the opposite ends of the bottom surface 804 in the X-axis direction. The Z-axis positive direction-side end portions of the bores 895 overlap the associated bolt bores 894 as viewed from the Y-axis direction.

The ECU 90 is supplied with, as inputs, detected values from the stroke sensor 94, the fluid pressure sensor 91, etc. and also information concerning running conditions from the vehicle-side, and controls the opening-closing operations of the electromagnetic valves 21, etc. and the rotational speed of the motor 20 (i.e. discharge rate of the pump 3) on the basis of programs stored therein, thereby controlling the wheel cylinder fluid pressure for each of the wheels FL to RR. Thus, the ECU 90 executes various brake control (antilock brake control for suppressing wheel slip due to braking; boost control for reducing the driver's brake operating force; brake control for vehicle motion control; automatic brake control such as preceding vehicle follow-up control; regenerative cooperative brake control, etc.). The vehicle motion control includes vehicle behavior stabilization control, e.g. sideslip prevention control. In the regenerative cooperative brake control, the wheel cylinder fluid pressure is controlled to achieve a target deceleration (target braking force) in cooperation with the regenerative brake.

The ECU 90 includes a braking operation quantity detecting section 90a, a target wheel cylinder fluid pressure calculating section 90b, a depression force brake creating section 90c, a boost control section 90d, and a control switching section 90e. The braking operation quantity detecting section 90a, upon receiving the input of a detected value from the stroke sensor 94, detects the amount of displacement (pedal stroke) of the brake pedal 100 as a braking operation quantity. The target wheel cylinder fluid pressure calculating section 90b calculates a target wheel cylinder fluid pressure. Specifically, the calculating section 90b calculates, on the basis of the detected pedal stroke, a predetermined boost ratio, i.e. a target wheel cylinder fluid pressure attaining ideal relational characteristics between the pedal stroke and the driver's request brake fluid pressure (vehicle deceleration G requested by the driver). During regenerative cooperative brake control, the calculating section 90b calculates a target wheel cylinder fluid pressure in relation to regenerative braking force. For example, the calculating section 90b calculates a target wheel cylinder fluid pressure such that the sum of the regenerative braking force input from the control unit of the regenerative braking device and the fluid pressure braking force corresponding to the target wheel cylinder fluid pressure satisfies the vehicle deceleration requested by the driver. It should be noted that, during motion control, the calculating section 90b calculates a target wheel cylinder fluid pressure for each of the wheels FL to RR on the basis of the detected vehicle motion state quantity (lateral acceleration or the like), for example, so as to attain a desired vehicle motion state.

The depression force brake creating section 90c puts the pump 3 into non-operating state and controls the shut-off valve 21 in the open direction and the SS/V IN 27 and the SS/V OUT 28 in the closed direction. In a state where the shut-off valve 21 is controlled in the open direction, the oil passage system (supply oil passage 11, etc.), which connects the fluid pressure chamber 50 of the master cylinder 5 and the wheel cylinders W/C, implements depression force brake in-boost control) that creates a wheel cylinder fluid pressure by a master cylinder fluid pressure generated by using the pedal depression force. It should be noted that the stroke simulator 6 does not function because the SS/V OUT 28 is controlled in the closed direction. That is, because the movement of the piston 61 in the stroke simulator 6 is suppressed, the flow of brake fluid from the fluid pressure chamber 50 (secondary chamber 50S) into the positive-pressure chamber 601 is suppressed. Consequently, it becomes possible to increase the wheel cylinder fluid pressure more efficiently. It should be noted that the S/V IN 27 may be controlled in the closed direction.

When the SS/V IN 27 is controlled in the closed direction and the SS/V OUT 28 is controlled in the open direction in a state where the shut-off valve 21 is controlled in the closed direction, the brake system (suction oil passage 12, discharge oil passage 13, etc.), which connects the reservoir 120 and the wheel cylinders W/C, functions as a brake-by-wire system that creates a wheel cylinder fluid pressure by a fluid pressure generated by using the pump 3 to implement boost control, regenerative cooperative control, etc. The boost control section 90d, when the driver performs a braking operation, activates the pump 3 and controls the shut-off valve 21 in the closed direction and the communication valve 23 in the open direction, thereby switching the state of the second unit 1B to a state where a wheel cylinder fluid pressure can be created by the pump 3. Thus, boost control is executed in which a wheel cylinder fluid pressure higher than the master cylinder fluid pressure is created by using the discharge pressure of the pump 3 as a fluid pressure source, thereby generating a fluid pressure braking force supplementing the driver's brake operating force. Specifically, the amount of brake fluid to be supplied from the pump 3 to the wheel cylinders W/C is adjusted by controlling the pressure-regulating valve 24 while operating the pump 3 at a predetermined rotational speed, thereby attaining a target wheel cylinder fluid pressure. That is, the brake apparatus 1 activates the pump 3 in the second unit 1B instead of the engine vacuum booster, thereby exhibiting a boost function to assist the brake operating force. Further, the boost control section 90d controls the SS/V IN 27 in the closed direction and the SS/V OUT 28 in the open direction. Thus, the stroke simulator 6 is made to function. The control switching section 90e switches between the depression force brake and the boost control by controlling the operation of the master cylinder 5 on the basis of the calculated target wheel cylinder fluid pressure. Specifically, the start of a braking operation is detected by the braking operation quantity detecting section 90a, and when the calculated target wheel cylinder fluid pressure is not higher than a predetermined value (corresponding to the maximum value of the vehicle deceleration G occurring at the time of normal braking, not sudden braking, for example), a wheel cylinder fluid pressure is created by the depression force brake creating section 90c. On the other hand, when the target wheel cylinder fluid pressure calculated at the time of depression of the brake pedal is higher than the above-described predetermined value, a wheel cylinder fluid pressure is created by the boost control section 90d.

Further, the ECU 90 includes a sudden braking operation state determination section 90f and a second depression force brake creating section 90g. The sudden braking state operation determination section 90f detects a braking operation state on the basis of an input from the braking operation quantity detecting section 90a, etc., and determines (judges) whether or not the braking operation state is a predetermined sudden braking operation state. For example, the determination section 90f decides whether or not the amount of change per unit time of pedal stroke has exceeded a predetermined threshold. The control switching section 90e, when the braking operation state is decided to be the sudden braking operation state, switches control so that a wheel cylinder fluid pressure is created by the second depression force brake creating section 90g. The second depression force brake creating section 90g activates the pump 3 and controls the shut-off valve 21 in the closed direction and further controls the SS/V IN 27 in the open direction and the SS/V OUT 28 in the closed direction. Thus, second depression force brake that creates a wheel cylinder fluid pressure by using a brake fluid flowing out from the back-pressure chamber 602 of the stroke simulator 6 is implemented and used until the pump 3 becomes able to generate a sufficiently high wheel cylinder fluid pressure. It should be noted that the shut-off valve 21 may be controlled in the open direction. The SS/V 27 may also be controlled in the closed direction. In such a case, the brake fluid from the back-pressure chamber 602 is supplied toward the wheel cylinders W/C through the check valve 270 (which is open because the pressure at the wheel cylinder W/C side is still lower than the pressure at the back-pressure chamber 602 side). In this embodiment, the brake fluid can be efficiently supplied from the back-pressure chamber 602 toward the wheel cylinders W/C because the SS/V IN 27 is controlled in the open direction. Thereafter, when the braking operation state is decided to be not the sudden braking operation state, and/or, when a predetermined condition is met which shows that the discharge capacity of the pump 3 has become satisfactory, the control switching section 90e switches control so that a wheel cylinder fluid pressure is created by the boost control section 90d. That is, the SS/V IN 27 is controlled in the closed direction, and the SS/V OUT 28 is controlled in the open direction. Thus, the stroke simulator 6 is made to function. It should be noted that control may be switched to the regenerative cooperative brake control after the second depression force brake.

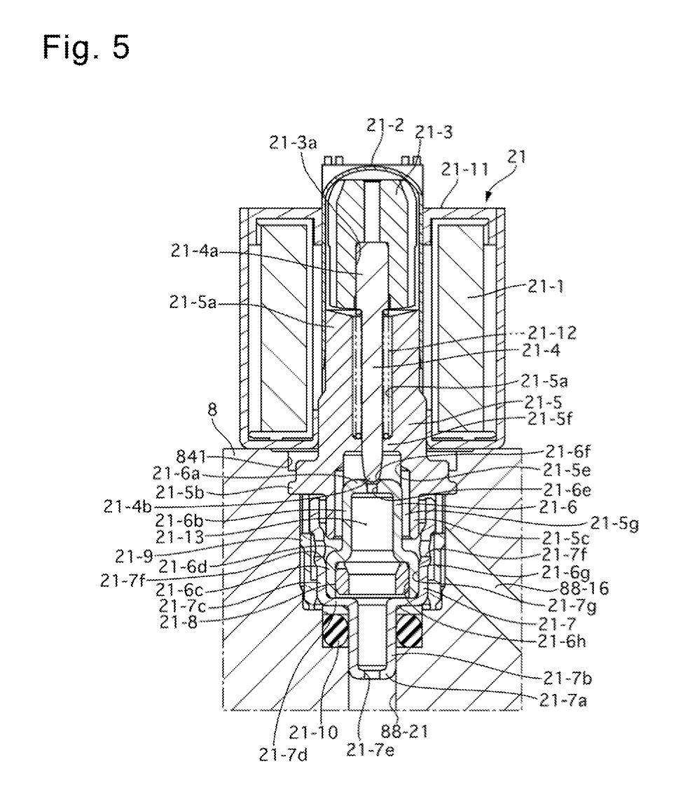

Next, the configurations of the shut-off valve 21, the SOL/V IN 22, the communication valve 23, the pressure-regulating valve 24, the SS/V IN 27, and the SS/V OUT 28 will be explained on the basis of FIGS. 5 to 13.

### [Shut-off Valve and Pressure Regulating Valve]

The shut-off valve 21 and the pressure-regulating valve 24 have the same structure; therefore, only the shut-off valve 21 will be explained.

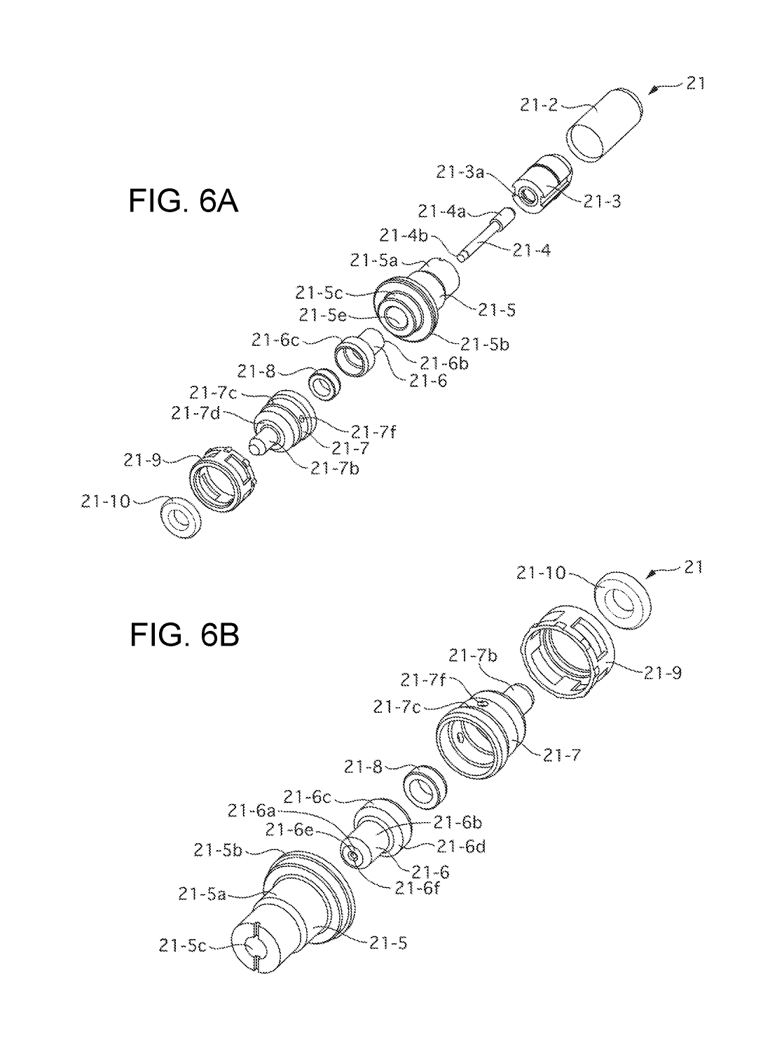

FIG. 5 is a longitudinal sectional view of the shut-off valve 21, and FIG. 6 is an exploded perspective view of the shut-off valve 21, of which: (a) is an illustration as viewed from the Y-axis positive direction side; and (b) is an illustration as viewed from the Y-axis negative direction side.

The shut-off valve 21 includes a coil 21-1, a cylinder 21-2, an armature (movable iron core) 21-3, a plunger (valve element) 21-4, a valve body 21-5, a seat member 21-6, a body member 21-7, a first filter member 21-8, a second filter member 21-9, and a seal member 21-10.

The coil 21-1 generates electromagnetic force when energized. The coil 21-1 is accommodated in a yoke 21-11 formed of a magnetic material.

The cylinder 21-2 is formed in the shape of a circular cylinder by using a non-magnetic material. The cylinder 21-2 is open at a Y-axis positive direction end thereof and closed at a Y-axis negative direction end thereof by a hemispherical bottom. The cylinder 21-2 is welded at Y-axis positive direction end to a first circular cylindrical portion 21-5a of the valve body 21-5 (described later).

The armature 21-3 is formed of a magnetic material and provided to be movable in the Y-axis direction in the cylinder 21-2. The armature 21-3 has a recess 21-3a formed in the center of the Y-axis positive direction end thereof. The plunger 21-4 is press-fitted in recess 21-3a. The armature 21-3 is, when the coil 21-1 is energized, moved in the Y-axis positive direction by electromagnetic force generated by the coil 21-1.

The plunger 21-4 is formed in the shape of a rod by using a non-magnetic material, e.g. a resin material. The plunger 21-4 is disposed in the cylinder 21-2 along the Y-axis direction. The plunger 21-4 includes a large-diameter portion 21-4a at a Y-axis negative direction side thereof. The large-diameter portion 21-4a is larger in diameter than the Y-axis positive direction end of the plunger 21-4. The plunger 21-4 includes a distal end 21-4b, which is a Y-axis positive direction end, formed a hemispherical shape. The large-diameter portion 21-4a is press-fitted in the recess 21-3a of the armature 21-3. The plunger 21-4 is driven integrally with the armature 21-3.

The valve both 21-5 is formed in the shape of a circular cylinder by using a magnetic material. The valve both 21-5 includes a first circular cylindrical portion 21-5a provided at a Y-axis negative direction side thereof to function as a magnetic path forming member. The valve body 21-5 further includes an enlarged-diameter swaged portion 21-5b, which is swaged to the housing 8, and a second circular cylindrical portion 21-5c provided at a Y-axis positive direction side thereof and inserted into the shut-off valve accommodating bore 841. The first circular cylindrical portion 21-5a has a first accommodating bore (insertion bore) 21-5d formed at the inner periphery thereof. The second circular cylindrical portion 21-5c has a second accommodating bore 21-5e formed at the inner periphery thereof, which is larger in diameter than the first accommodating bore 21-5d. A retaining portion 21-5f is formed at the Y-axis positive direction end of the first accommodating bore 21-5d. The retaining portion 21-5f projects radially inward. A coil spring (resilient member) 21-12 is compressedly interposed between the retaining portion 21-5f and the large-diameter portion 21-4a of the plunger 21-4. The coil spring 21-12 biases the plunger 21-4 in the Y-axis negative direction. The second accommodating bore 21-5e is formed with a plurality of axial oil passages 21-5g.

The seat member 21-6 is disposed in the shut-off valve accommodating bore 841. The seat member 21-6 is formed in the shape of a circular cylinder having a bottom portion 21-6a at a Y-axis negative direction end thereof and open at a Y-axis positive direction end thereof. The seat member 21-6 includes a small-diameter portion 21-6b, a large-diameter portion 21-6c, and a first step portion 21-6d. The small-diameter portion 21-6b includes the bottom portion 21-6a. The small-diameter portion 21-6b is provided closer to the Y-axis negative direction side and press-fitted and secured in the second accommodating bore 21-5e in the valve body 21-5. The bottom portion 21-6a is formed with a first communication bore 21-6e. Around the first communication bore 21-6e is formed a valve seat 21-6f against which the distal end 21-4b of the plunger 21-4 abuts. The large-diameter portion 21-6c is provided closer to the Y-axis positive direction side than the small-diameter portion 21-6b and formed larger in diameter than the small-diameter portion 21-6b. The first step portion 21-6d extends in a direction approximately perpendicular to the Y-axis direction to connect the small-diameter portion 21-6b and the large-diameter portion 21-6c.

The body member 21-7 is disposed in the shut-off valve accommodating bore 841 at a position outside the seat member 21-6. The body member 21-7 includes a bottom portion 21-7a at a Y-axis positive direction end thereof and further includes a small-diameter portion 21-7b, a large-diameter portion 21-7c, and a second step portion 21-7d. The small-diameter portion 21-7b includes the bottom portion 21-7a and is provided closer to the Y-axis positive direction side. The bottom portion 21-7a is formed with a second communication bore 21-7e. The second communication bore 21-7e is connected to the first bore 88-21. The large-diameter portion 21-7c is provided closer to the Y-axis negative direction side than the small-diameter portion 21-7b and formed larger in diameter than the small-diameter portion 21-7b. The large-diameter portion 21-6c of the seat member 21-6a fitted in the large-diameter portion 21-7c. The large-diameter potion 21-7c is provided on its inner peripheral surface with an inner abutment surface 21-7g abutting against an outer peripheral surface 21-6g of the large-diameter portion 21-6c of the seat member 21-6a. The large-diameter portion 21-7c has a plurality of flow bores 21-7f formed closer to the Y-axis negative direction side than the inner abutment surface 21-7g. The flow bores 21-7f are connected to the sixth bore 88-16. The second step portion 21-7d extends in a direction approximately perpendicular to the Y-axis direction to connect the small-diameter portion 21-7b and the large-diameter portion 21-7c. An internal space surrounded by the seat member 21-6 and the body member 21-7 is a flow path (internal oil passage) 21-13 through which the brake fluid flows.

The first filter member 21-8 is provided in the flow path 21-13. The first filter member 21-8 filters the brake fluid flowing into the first communication bore 21-6e from the second communication bore 21-7e, thereby preventing contamination or the like in the brake fluid from being caught on the plunger 21-4 or the valve seat 21-6f. The first filter member 21-8 is engaged with the first step portion 21-6d of the seat member 21-6 and the second step portion 21-7d of the body member 21-7, thereby being held in position in the Y-axis direction. The first filter member 21-8 is provided to face an inner peripheral surface 21-6h of the large-diameter portion 21-6c of the seat member 21-6. A clearance smaller than the mesh size of a mesh portion 21-8a (described later) is formed between the inner peripheral surface 21-6h of the seat member 21-6 and an outer peripheral surface 21-8c of the first filter member 21-8.

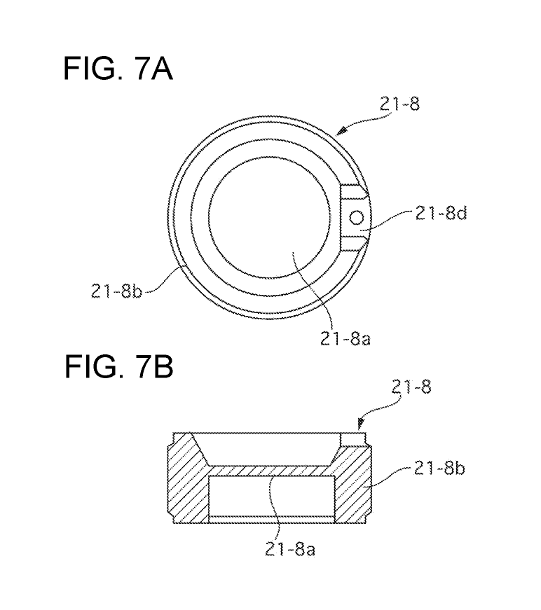

FIG. 7 is an illustration showing the shape of the first filter member 21-8, of which: (a) is a plan view; and (b) is a sectional side view. The first filter member 21-8 is injection-molded by using a resin material, and includes a mesh portion 21-8a and a frame body 21-8b. The mesh portion 21-8a is formed in the shape of a mesh having a predetermined mesh size. The frame body 21-8b is formed in the shape of a ring and provided around the outer periphery of the mesh portion 21-8a. The frame body 21-8b has a recess 21-8d formed in one end surface thereof at a position corresponding to the gate. The provision of the recess 21-8d makes it possible to prevent the gate residual height from exceeding the one end surface of the frame body 21-8b. The first filter member 21-8 is disposed with the recess 21-8d facing in the Y-axis negative direction.

The second filter member 21-9 is injection-molded by using a resin material. The second filter member 21-9 is disposed outside the body member 21-7 to overlap the first filter member 21-8 in the Y-axis direction. The second filter member 21-9 filters the brake fluid flowing into the flow bores 21-7f from the sixth bore 88-16, thereby preventing contamination or the like in the brake fluid from being caught on the plunger 21-4 or the valve seat 21-6f.

The seal member 21-10 is an O-ring and fitted onto the outer periphery of the small-diameter portion 21-7b of the body member 21-7 to seal between the outer peripheral surface of the small-diameter portion 21-7b and the inner peripheral surface of the shut-off valve accommodating bore 841.

Next, the operation of the shut-off valve 21 will be explained.

When the coil 21-1 is not energized, the distal end 21-4b of the plunger 21-4 is separate from the valve seat 21-6f because the armature 21-3 and the plunger 21-4 are being biased in the Y-axis negative direction by the biasing force of the coil spring 21-12. Accordingly, the sixth bore 88-16 and the first bore 88-21 are communicated with each other through the flow bores 21-7f, the axial oil passages 21-5g, the first communication bore 21-6e, and the second communication bore 21-7e.

When the coil 21-1 is energized with a predetermined electric current, a magnetic path is formed through the yoke 21-11, the armature 21-3, and the first circular cylindrical portion 21-5a, and attractive force is generated between the armature 21-3 and the first circular cylindrical portion 21-5a. The attractive force causes the armature 21-3 and the plunger 21-4 to move in the Y-axis positive direction, and when the distal end 21-4b of the plunger 21-4 abuts against the valve seat 21-6f, the communication between the sixth bore 88-16 and the first bore 88-21 is cut off. If electric power supplied to the coil 21-1 is controlled by PWM control and the attractive force is proportionally controlled, the clearance (flow path sectional area) between the distal end 21-4b and the valve seat 21-6f can be controlled. Thus, a desired flow rate (fluid pressure) can be attained.

In the following explanation, each part of the pressure-regulating valve 24 will be denoted by a reference sign used to denote the same part of the shut-off valve 21, with the numeral “21” replaced by “24”.

### [SOL/V IN]

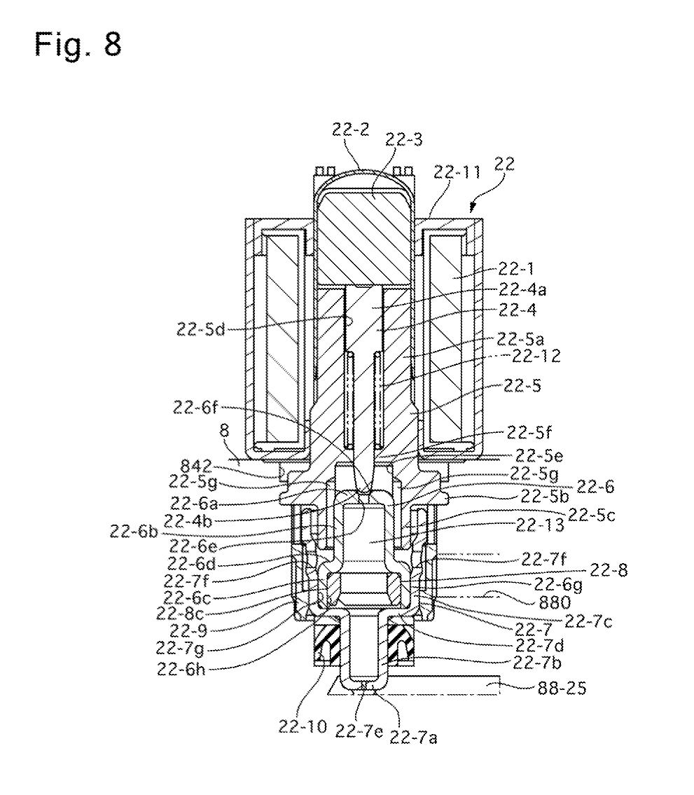

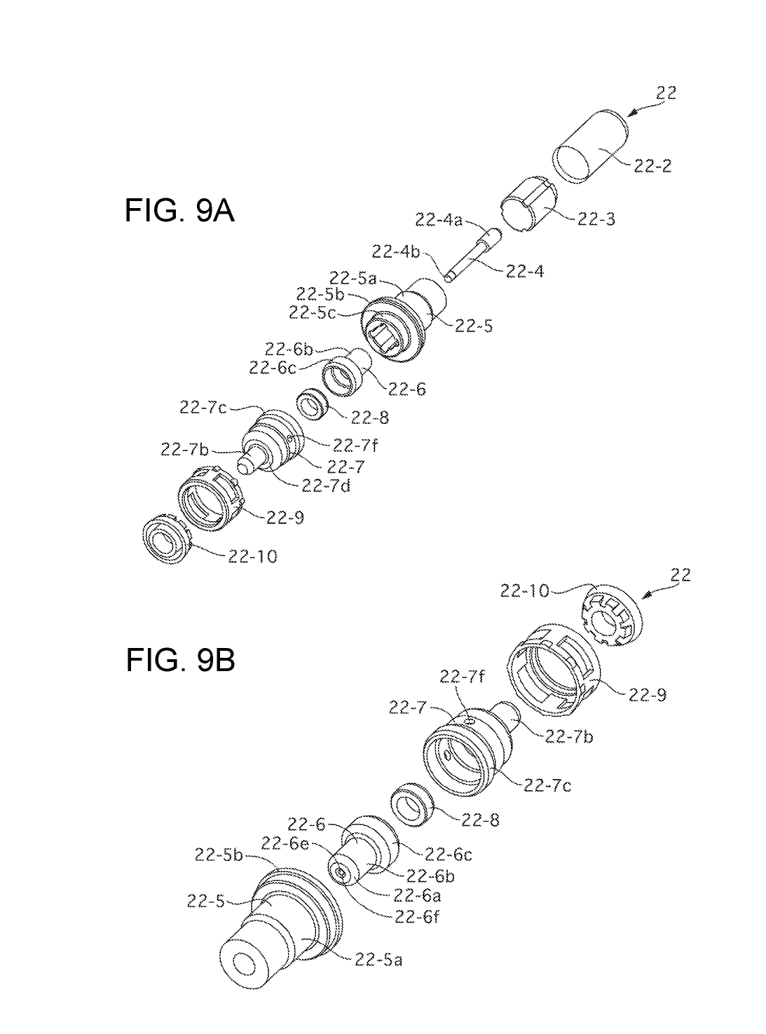

FIG. 8 is a longitudinal sectional view of the SOL/V IN 22, and FIG. 9 is an exploded perspective view of the SOL/V IN 22, of which: (a) is an illustration as viewed from the Y-axis positive direction side; and (b) is an illustration as viewed from the Y-axis negative direction side.

The SOL/V IN 22 includes a coil 22-1, a cylinder 22-2, an armature (movable iron core) 22-3, a plunger (valve element) 22-4, a valve body 22-5, a seat member 22-6, a body member 22-7, a first filter member 22-8, a second filter member 22-9, and a seal member 22-10.

The coil 22-1 generates electromagnetic force When energized. The coil 22-1 is accommodated in a yoke 22-11 formed of a magnetic material.

The cylinder 22-2 is formed in the shape of a circular cylinder by using a non-magnetic material. The cylinder 22-2 is open at to Y-axis positive direction end thereof and closed at a Y-xis negative direction end thereof by a hemispherical bottom. The cylinder 22-2 is welded at its Y-axis positive direction end to a first circular cylindrical portion 22-5a of the valve body 22-5 (described later).

The armature 22-3 is formed of a magnetic material and provided to be movable in the cylinder 22-2 in the Y-axis direction. The armature 22-3 is, when the coil 22-1 is energized, moved in the Y-axis positive direction by electromagnetic force generated by the coil 22-1.

The plunger 22-4 is formed in the shape of a rod by using a non-magnetic material, e.g, a resin material. The plunger 22-4 is disposed in the cylinder 22-2 along the Y-axis direction. The plunger 22-4 includes a large-diameter portion 22-4a at a Y-axis negative direction side thereof. The large-diameter portion 22-4a is larger in diameter than the Y-axis positive direction end of the plunger 22-4. The plunger 22-4 includes a distal end 22-4b, which is a Y-axis positive direction end, formed in a hemispherical shape. The large-diameter portion 22-4a includes a Y-axis negative direction end abutting against the Y-axis positive direction end of the armature 22-3. The plunger 22-4 is driven integrally with the armature 22-3.

The valve body 22-5 is formed in the shape of a circular cylinder by using a magnetic material. The valve body 22-5 includes a first circular cylindrical portion 22-5a provided at a Y-axis negative direction side to function as a magnetic path forming member. The valve body 22-5 further includes an enlarged-diameter swaged portion 22-5b, which is swaged to the housing 8, and a second circular cylindrical portion 22-5c provided at a Y-axis positive direction side and inserted in the SOL/V IN accommodating bore 842. The first circular cylindrical portion 22-5a has a first accommodating bore (insertion bore) 22-5d formed at the inner periphery thereof. The second circular cylindrical portion 22-5c has a second accommodating bore 22-5e formed at the inner periphery thereof, which is larger in diameter than the first accommodating bore 22-5d. A retaining portion 22-5f is formed at the Y-axis positive direction end of the first accommodating bore 22-5d. The retaining portion 22-5f projects radially inward. A coil spring (resilient member) 22-12 is compressedly interposed between the retaining portion 22-5f and the large-diameter portion 22-4a of the plunger 22-4. The coil spring 22-12 biases the plunger 22-4 in the Y-axis negative direction. The second accommodating bore 22-5e is formed with a plurality of axial oil passages 22-5g.

The seat member 22-6 is disposed in the SOL/V IN accommodating bore 842. The seat member 22-6 is formed in the shape of a circular cylinder having a bottom portion 22-6a at a Y-axis negative direction end thereof and open at a Y-axis positive direction end thereof. The seat member 22-6 includes a small-diameter portion 22-6b, a large-diameter portion 22-6c, and a first step portion 22-6d. The small-diameter portion 22-6b includes the bottom portion 22-6a. The small-diameter portion 22-6b is provided closer to the Y-axis negative direction side and press-fitted and secured in the second accommodating bore 22-5e in the valve body 22-5. The bottom portion 22-6a is formed with a first communication bore 22-6e. Around the first communication bore 22-6e is formed a valve seat 22-6f against which the distal end 22-4b of the plunger 22-4 abuts. The large-diameter portion 22-6c is provided closer to the Y-axis positive direction side than the small-diameter portion 22-6b and formed larger in diameter than the small-diameter portion 22-6b. The first step portion 22-6d extends in a direction approximately perpendicular to the Y-axis direction to connect the small-diameter portion 22-6b and the large-diameter portion 22-6c.

The body member 22-7 is disposed in the SOL/V IN accommodating bore 842 at a position outside the seat member 22-6. The body member 22-7 includes a bottom portion 22-7a at a Y-axis positive direction end thereof and further includes a small-diameter portion 22-7b, a large-diameter portion 22-7c, and a second step portion 22-7d. The small-diameter portion 22-7b includes the bottom portion 22-7a and is provided closer to the Y-axis positive direction side. The bottom portion 22-7a is formed with a second communication bore 22-7e. The second communication bore 22-7e is connected to the fifth bore 88-25. The large-diameter portion 22-7c is provided closer to the Y-axis negative direction side than the small-diameter portion 21-7b and formed larger in diameter than the small-diameter portion 22-7b. The large-diameter portion 22-6c of the seat member 22-6a is fitted in the large-diameter portion 22-7c. The large-diameter portion 22-7c is provided on its inner peripheral surface with an inner abutment surface 22-7g abutting against an outer peripheral surface 22-6g of the large-diameter portion 22-6c of the seat member 22-6a. The large-diameter portion 22-7c has a plurality of flow bores 22-7f formed closer to the Y-axis negative direction side than the inner abutment surface 22-7g. The flow bores 22-7f are connected to the oil passage bore 880. The second step portion 22-7d extends in a direction approximately perpendicular to the Y-axis direction to connect the small-diameter portion 22-7b and the large-diameter portion 22-7c. An internal space surrounded by the seat member 22-6 and the body member 22-7 is a flow path (internal oil passage) 22-13 through which the brake fluid flows.

The first filter member 22-8 is provided in the flow path 22-13. The first filter member 22-8 filters the brake fluid flowing into the first communication bore 22-6e from the second communication bore 22-7e, thereby preventing contamination or the like in the brake fluid from being caught on the plunger 22-4 or the valve seat 22-6f. The first filter member 22-8 is engaged with the first step portion 22-6d of the seat member 22-6 and the second step portion 22-7d of the body member 22-7, thereby being held in position in the Y-axis direction. The first filter member 22-8 is provided to face an inner peripheral surface 22-6h of the large-diameter portion 22-6c of the seat member 22-6. A clearance smaller than the mesh size of a mesh portion 22-8a (described later) is formed between the inner peripheral surface 22-6h of the seat member 22-6 and an outer peripheral surface 22-8c of the first filter member 22-8. The shape of the first filter member 22-8 is the same as that of the first filter member 21-8 shown in FIG. 7; therefore, a description thereof is omitted. The first filter member 22-8 is disposed with the recess facing in the Y-axis positive direction.

The second filter member 22-9 is injection-molded by using a resin material. The second filter member 22-9 is disposed outside the body member 22-7 to overlap the first filter member 22-8 in the Y-axis direction. The second filter member 22-9 filters the brake fluid flowing into the flow bores 22-7f from the oil passage bore 880, thereby preventing contamination or the like in the brake flold from being caught on the plunger 22-4 or the valve seat 22-6f.

The seal member 22-10 is a cup seal and fitted onto the outer periphery of the small-diameter portion 22-7b of the body member 22-7. The seal member 22-10 seals the leakage of brake fluid from the fifth bore 88-25 into the oil passage bore 880 when (the fluid pressure in the fifth bore 88-25>the fluid pressure in the oil passage bore 880) and allows the flow of brake fluid from the oil passage bore 880 into the fifth bore 88-25 when (the fluid pressure in the fifth bore 88-25<the fluid pressure in the oil passage bore 880). Thus, the seal member 22-10 performs the function of the cheek valve 220.

Next, the operation of the SOL/V IN 22 will be explained.

When the coil 22-1 is not energized, the distal end 22-4b of the plunger 22-4 is separate from the valve seat 22-6f because the armature 22-3 and the plunger 22-4 are being biased in the Y-axis negative direction by the biasing force of the coil spring 22-12. Accordingly, the fifth bore 88-25 and the oil passage bore 880 are communicated with each other through the flow bores 22-7f, the axial oil passages 22-5g, the first communication bore 22-6e, and the second communication bore 22-7e.

When the coil 22-1 is energized with a predetermined electric current, a magnetic path is formed through the yoke 22-11, the armature 22-3, and the first circular cylindrical portion 22-5a, and attractive force is generated between the armature 22-3 and the first circular cylindrical portion 22-5a. The attractive force causes the armature 22-3 and the plunger 22-4 to move in the Y-axis positive direction, and when the distal end 22-4b of the plunger 22-4 abuts against the valve seat 22-6f, the communication between the fifth bore 88-25 and the oil passage bore 880 is cut off. If electric power supplied to the coil 22-1 is controlled by PWM control and the attractive force is proportionally controlled, the clearance (flow path sectional area) between the distal end 22-4b and the valve seat 22-6f can be controlled. Thus, a desired flow rate (fluid pressure) can be attained.

### [Communication Valve]

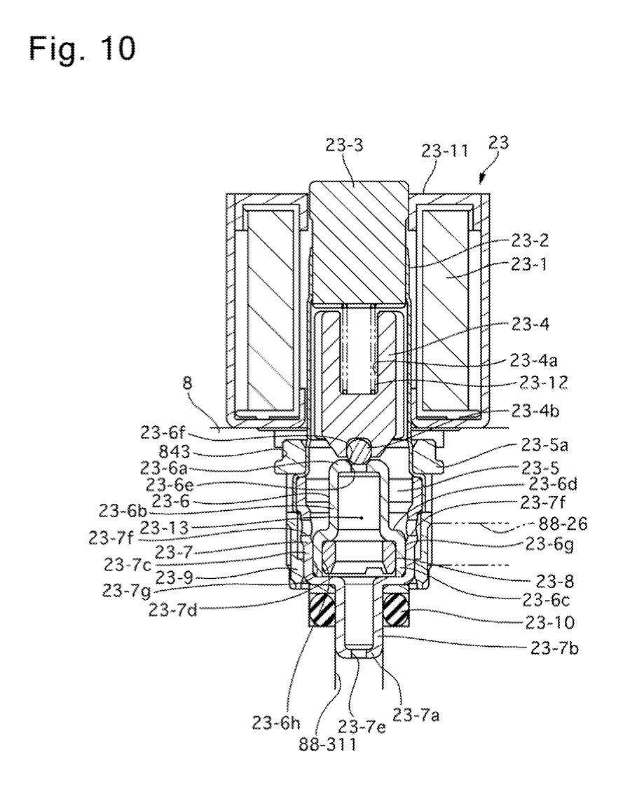

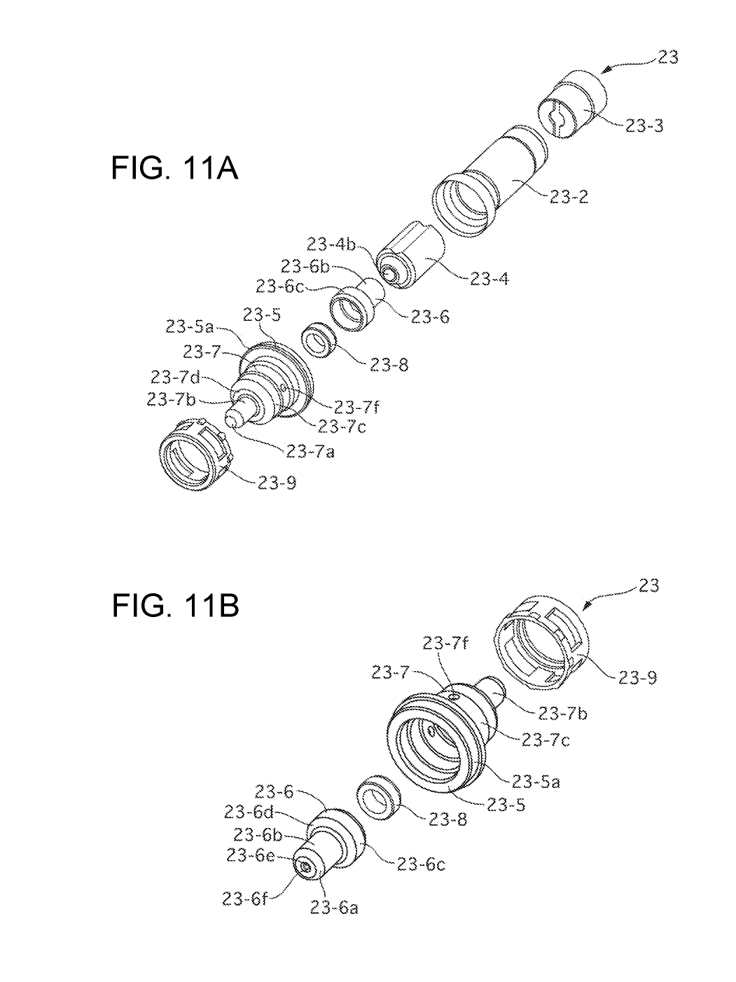

FIG. 10 is a longitudinal sectional view of the communication valve 23, and FIG. 11 is an exploded perspective view of the communication valve 23, of which: (a) is an illustration as viewed from the Y-axis positive direction side; and (b) is an illustration as viewed from the Y-axis negative direction side.

The communication valve 23 includes a coil 23-1, a cylinder 23-2, a body center (fixed iron core) 23-3, an armature (valve element; movable iron core) 23-4, a flange ring 23-5, a seat member 23-6, a body member 23-7, a first filter member 23-8, a second filter member 23-9, and a seal member 23-10.

The coil 23-1 generates electromagnetic force when energized. The coil 23-1 is accommodated in a yoke 23-11 formed of a magnetic material.

The cylinder 23-2 is formed in the shape of a circular cylinder by using a non-magnetic material. The circular cylinder is open at both ends thereof. The both center 23-3 is formed of a magnetic material. The body center 23-3 is welded at its Y-axis positive direction end to the Y-axis negative direction end of the cylinder 23-2. The body center 23-3, when the coil 23-1 is energized, attracts the armature 23-4 by electromagnetic force generated by the coil 23-1.

The armature 23-4 is formed of a magnetic material. The armature 23-4 is disposed in the cylinder 23-2 along the Y-axis direction. The armature 23-4 has a recess 23-4a at a Y-axis negative direction end thereof. The recess 23-4a extends in the Y-axis positive direction. A coil spring (resilient member) 23-12 is compressedly interposed between the bottom of the recess 23-4a and the body center 23-3. The coil spring 23-12 biases the armature 23-4 in the Y-axis positive direction. When the coil 23-1 is not energized, a predetermined gap is provided between the Y-axis positive direction end of the cylinder 23-2 and the Y-axis negative direction end of the armature 23-4. A spherical valve element 23-4b is secured to the Y-axis positive direction end of the armature 23-4.

The flange ring 23-5 is formed in the shape of a circular cylinder by using a magnetic material. The circular cylinder is open at both ends thereof. The flange ring 23-5 is disposed in the communication valve accommodating bore 843. The flange ring 23-5 includes an enlarged-diameter swaged portion 23-5a, which is swaged to the housing 8.

The seat member 23-6 is disposed in the communication valve accommodating bore 843. The seat member 23-6 is formed in the shape of a circular cylinder having a bottom portion 23-6a at a Y-axis negative direction end thereof and open at a Y-axis positive direction end thereof. The seat member 23-6 includes a small-diameter portion 23-6b, a large-diameter portion 23-6c, and a first step portion 23-6d. The small-diameter portion 23-6b has the bottom portion 23-6a and is provided closer to the Y-axis negative direction side. The bottom portion 23-6a is formed with a first communication bore 23-6e. Around the first communication bore 23-6e is formed a valve seat 23-6f against which the distal end 23-4b of the armature 23-4 abuts. The large-diameter portion 23-6c is provided closer to the Y-axis positive direction side than the small-diameter portion 23-6b and formed larger in diameter than the small-diameter portion 23-6b. The first step portion 23-6d extends in a direction approximately perpendicular to the Y-axis direction to connect the small-diameter portion 23-6b and the large-diameter portion 23-6c.

The body member 23-7 is disposed in the communication valve accommodating bore 843 at a position outside the seat member 23-6. The body member 23-7 includes a bottom portion 23-7a at a Y-axis positive direction end thereof and further includes a small-diameter portion 23-7b, a large-diameter portion 23-7c, and a second step portion 23-7d. The small-diameter portion 23-7b includes the bottom portion 23-7a and is provided closer to the Y-axis positive direction side. The bottom portion 23-7a is formed with a second communication bore 23-7e. The second communication bore 23-7e is connected to the eleventh bore 88-311. The large-diameter portion 23-7c is provided closer to the Y-axis negative direction side than the small-diameter portion 23-7b and formed larger in diameter than the small-diameter portion 23-7b. The large-diameter portion 23-6c of the seat member 23-6 is fitted in the large-diameter portion 23-7c. The large-diameter portion 23-7c is press-fitted and secured at the Y-axis positive direction end of the cylinder 23-2. The large-diameter portion 23-7c is provided on its inner peripheral surface with an inner abutment surface 23-7g abutting against an outer peripheral surface 23-6g of the large-diameter portion 23-6c of the seat member 23-6a. The large-diameter portion 23-7c has a plurality of flow bores 23-7f formed closer to the Y-axis negative direction side than the inner abutment surface 23-7g. The flow bores 23-7f are connected to the sixth bore 88-26. The second step portion 23-7d extends in a direction approximately perpendicular to the Y-axis direction to connect the small-diameter portion 23-7b and the large-diameter portion 23-7c. An internal space surrounded by the seat member 23-6 and the body member 23-7 is a flow path (internal oil passage) 23-13 through which the brake fluid flows.

The first filter member 23-8 is provided in the flow path 23-13. The first filter member 23-8 filters the brake fluid flowing into the first communication bore 23-6e from the second communication bore 23-7e, thereby preventing contamination or the like in the brake fluid from being caught on the armature 23-4 or the valve seat 23-6f. The first filter member 23-8 is engaged with the first step portion 23-6d of the seat member 23-6 and the second step portion 23-7d of the body member 23-7, thereby being held in position in the Y-axis direction. The first filter member 23-8 is provided to face an inner peripheral surface 23-6h of the large-diameter portion 23-6c of the seat member 23-6. A clearance smaller than the mesh size of a mesh portion 23-8a (described later) is formed between the inner peripheral surface 23-6h of the seat member 23-6 and an outer peripherial surface 23-8c of the first filter member 23-8. The shape of the first filter member 23-8 is the same as that of the first filter member 21-8 shown in FIG. 7; therefore, a description thereof is omitted. The first filter member 23-8 is disposed with the recess facing in the Y-axis negative direction.

The second filter member 23-9 is injection-molded by using a resin material. The second filter member 23-9 is disposed outside the body member 23-7 to overlap the first filter member 23-8 in the Y-axis direction. The second filter member 23-9 filters the brake fluid flowing into the flow bores 23-7f from the eleventh bore 88-311, thereby preventing contamination or the like in the brake fluid from being caught on the armature 23-4 or the valve seat 23-6f.

The seal member 23-10 is an O-ring, which is fitted onto the outer periphery of the small-diameter portion 23-7b of the body member 23-7 to seal between the outer peripheral surface of the small-diameter portion 23-7b and the inner peripheral surface of the communication valve accommodating bore 843.

Next, the operation of the communication valve 23 will be explained.

When the coil 23-1 is not energized, the distal end 23-4b of the armature 23-4 is abutting against the valve seat 23-6f because the armature 23-4 is being biased in the Y-axis positive direction by the biasing force of the coil spring 23-12. Accordingly, the communication between the sixth bore 88-26 and the eleventh bore 88-311 is cut off.

When the coil 21-1 is energized with a predetermined electric current, a magnetic path is formed through the yoke 23-11, the body center 23-3, and the armature 23-4, and attractive force is generated between the body center 23-3 and the armature 23-4. The attractive force causes the armature 23-4 to move in the Y-axis negative direction, and when the distal end 23-4b of the armature 23-4 separates from the valve seat 23-6f, the sixth bore 88-26 and the eleventh bore 88-311 are communicated with each other through the flow bores 23-7f, the axial oil passages 23-5g, the first communication bore 23-6e, and the second communication bore 23-7e.

### [SS/V IN and SS/V OUT]

The SS/V IN 27 and the SS/V OUT 28 have the same structure; therefore, only the SS/V IN 27 will be explained.

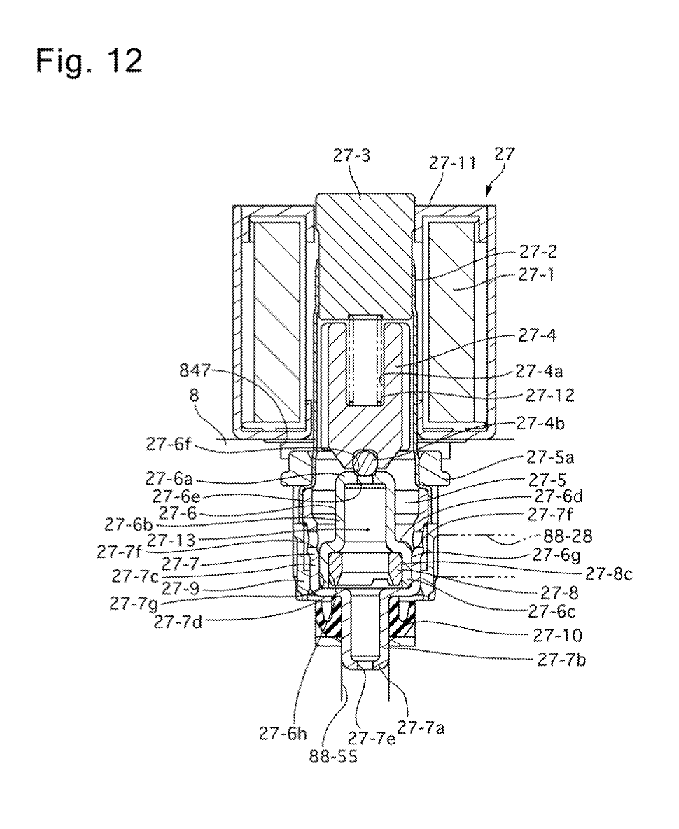

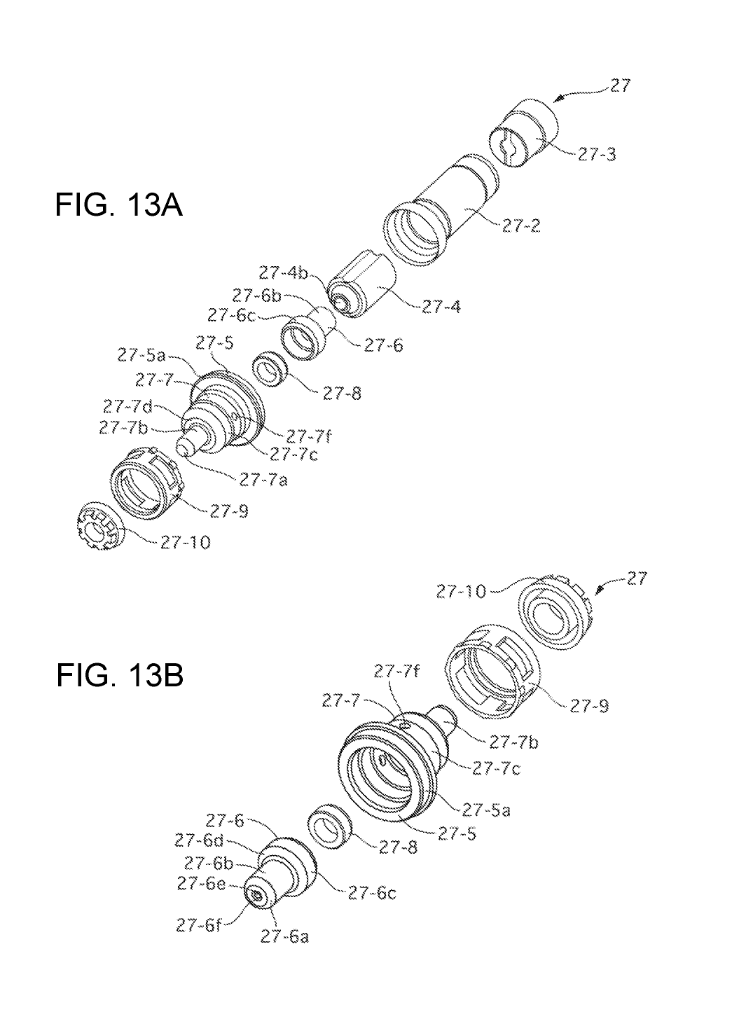

FIG. 12 is a longitudinal sectional view of the SS/V IN 27, and FIG. 13 is an exploded perspective view of the SS/V IN 27, of which: (a) is an illustration as viewed from the Y-axis positive direction side; and (b) is an illustration as viewed from the Y-axis negative direction side.

The SS/V IN 27 includes a coil 27-1, a cylinder 27-2, a body center (fixed iron core) 27-3, an armature (valve element) 27-4, a flange ring 27-5, a seat member 27-6, a body member 27-7, a first filter member 27-8, a second filter member 27-9, and a seal member 27-10.

The coil 27-1 generates electromagnetic force when energized. The coil 27-1 is accommodated in a yoke 27-11 formed of a magnetic material.

The cylinder 27-2 is formed in the shape of a circular cylinder by using a non-magnetic material. The circular cylinder is open at both ends thereof.

The body center 27-3 is formed of a magnetic material. The body center 27-3 is welded at its Y-axis positive direction end to the Y-axis negative direction end of the cylinder 27-2. The body center 27-3, when the coil 27-1 is energized, attracts the armature 27-4 by electromagnetic force generated by the coil 27-1.

The armature 27-4 is formed of a magnetic material. The armature 27-4 is disposed in the cylinder 27-2 along the Y-axis direction. The armature 27-4 has a recess 27-4a at a Y-axis negative direction end thereof. The recess 27-4a extends in the Y-axis positive direction. A coil spring (resilient member) 27-12 is compressedly interposed between the bottom of the recess 27-4a and the body center 27-3. The coil spring 27-12 biases the armature 27-4 in the Y-axis positive direction. When the coil 27-1 is not energized, a predetermined gap is provided between the Y-axis positive direction end of the cylinder 27-2 and the Y-axis negative direction end of the armature 27-4. A spherical valve element 27-4b is secured to the Y-axis positive direction end of the armature 27-4.

The flange ring 27-5 is formed in the shape of a circular cylinder by using a magnetic material. The circular cylinder is open at both ends thereof. The flange ring 27-5 is disposed in the SS/V IN accommodating bore 847. The flange ring 27-5 includes an enlarged-diameter swaged portion 27-5a, which is swaged to the housing 8.

The seat member 27-6 is disposed in the SS/V IN accommodating bore 847. The seat member 27-6 is formed in the shape of a circular cylinder having a bottom portion 27-6a at a Y-axis negative direction end thereof and open at a Y-axis positive direction end thereof. The seat member 27-6 includes a small-diameter portion 27-6b, a large-diameter portion 27-6c, and a first step portion 27-6d. The small-diameter portion 27-6b includes the bottom portion 27-6a and is provided closer to the Y-axis negative direction side. The bottom portion 27-6a is formed with a first communication bore 27-6e. Around the first communication bore 27-6e is formed a valve seat 27-6f against which the distal end 27-4b of the armature 27-4 abuts. The large-diameter portion 27-6c is provided closer to the Y-axis positive direction side than the small-diameter portion 27-6b and formed larger in diameter than the small-diameter portion 27-6b. The first step portion 27-6d extends in a direction approximately perpendicular to the Y-axis direction to connect the small-diameter portion 27-6b and the large-diameter portion 27-6c.

The body member 27-7 is disposed in the SS/V IN accommodating bore 847 at a position outside the seat member 27-6. The body member 27-7 includes a bottom portion 27-7a at a Y-axis positive direction end thereof and further includes a small-diameter portion 27-7b, a large-diameter portion 27-7c, and a second step portion 27-7d. The small-diameter portion 27-7b includes the bottom portion 27-7a and is provided closer to the Y-axis positive direction side. The bottom portion 27-7a is formed with a second communication bore 27-7e. The second communication bore 27-7e is connected to the fifth bore 88-55. The large- diameter portion 27-7c is provided closer to the Y-axis negative direction side than the small-diameter portion 27-7b and formed larger in diameter than the small-diameter portion 27-7b. The large-diameter portion 27-6c of the seat member 27-6 is fitted in the large-diameter portion 27-7c. The large-diameter portion 27-7c is press-fitted and secured at the Y-axis positive direction end of the cylinder 27-2. The large-diameter portion 27-7c is provided on its inner peripheral surface with an inner abutment surface 27-7g abutting against an outer peripheral surface 27-6g of the large-diameter portion 27-6c of the seat member 27-6a. The large-diameter portion 27-7c has a plurality of flow bores 27-7f formed closer to the Y-axis negative direction side than the inner abutment surface 27-7g. The flow bores 27-7f are connected to the eighth bore 88-28. The second step portion 27-7d extends in a direction approximately perpendicular to the Y-axis direction to connect the small-diameter portion 27-7b and the large-diameter portion 27-7c. An internal space surrounded by the seat member 27-6 and the body member 27-7 is a flow path (internal oil passage) 27-13 through which the brake fluid flows.

The first filter member 27-8 is provided in the flow path 27-13. The first filter member 27-8 filters the brake fluid flowing into the first communication bore 27-6e from the second communication bore 27-7e, thereby preventing contamination or the like in the brake fluid from being caught on the armature 27-4 or the valve seat 27-6f. The first filter member 27-8 is engaged with the first step portion 27-6d of the seat member 27-6 and the second step portion 27-7d of the body member 27-7, thereby being held in position in the Y-axis direction. The first filter member 27-8 is provided to face an inner peripheral surface 27-6h of the large-diameter portion 27-6c of the seat member 27-6. A clearance smaller than the mesh size of a mesh portion 27-8a (described later) is formed between the inner peripheral surface 27-6h of the seat member 27-6 and an outer peripheral surface 27-8c of the first filter member 27-8. The shape of the first filter member 27-8 is the same as that of the first filter member 21-8 shown in FIG. 7; therefore, a description thereof is omitted. The first filter member 27-8 is disposed with the recess facing in the Y-axis positive direction.

The second filter member 27-9 is injection-molded by using a resin material. The second filter member 27-9 is disposed at a position outside the body member 27-7 to overlap the first filter member 27-8 in the Y-axis direction. The second filter member 27-9 filters the brake fluid flowing into the flow bores 27-7f from the eighth bore 88-28, thereby preventing contamination or the like in the brake fluid from being caught on the armature 27-4 or the valve seat 27-6f.

The seal member 27-10 is a cup seal, which is fitted onto the outer periphery of the small-diameter portion 27-7b of the body member 27-7. The seal member 27-10 seals the leakage of brake fluid from the eighth bore 88-28 into the fifth bore 88-55 when (the fluid pressure in the eighth bore 88-28>the fluid pressure in the fifth bore 88-55) and allows the flow of brake fluid from the fifth bore 88-55 into the eighth bore 88-28 when the fluid pressure in the eighth bore 88-28<the fluid pressure in the oil passage bore 880). Thus, the seal member 27-10 performs the function of the check valve 270.

Next, the operation of the SS/V IN 27 will be explained.

When the coil 27-1 is not energized, the distal end 27-4b of the armature 27-4 is abutting against the valve seat 27-6f because the armature 27-4 is being biased in the Y-axis positive direction by the biasing force of the coil spring 27-12. Accordingly, the communication between the fifth bore 88-55 and the eighth bore 88-28 is cut off.

When the coil 27-1 is energized with a predetermined electric current, a magnetic path is formed through the yoke 27-11, the body center 27-3, and the armature 27-4, and attractive force is generated between the body center 27-3 and the armature 27-4. The attractive force causes the armature 27-4 to move in the Y-axis negative direction, and when the distal end 27-4b of the armature 27-4 separates from the valve seat 27-6f, the fifth bore 88-55 and the eighth bore 88-28 are communicated with each other through the flow bores 27-7f, the axial oil passages 27-5g, the first communication bore 27-6e, and the second communication bore 23-7e.

In the following explanation, each part of the SS/V OUT 28 will be denoted by a reference sign used to denote the same part of the SS/V IN 27, with the numeral “27” replaced by “28”.

### [Suppression of Increase in Size in Axial Direction]

In the second unit 1B of the first embodiment, the shut-off valve 21, the SOL/V IN 22, the communication valve 23, the pressure-regulating valve 24, the SS/V IN 27, and the SS/V OUT 28 need two filter members to prevent the inflow of contamination because the brake fluid flows bidirectionally. In the conventional electromagnetic valve, a filter member for preventing the inflow of contamination from one direction is provided at an axial end of the electromagnetic valve; therefore, the electromagnetic valve may be increased in size in the axial direction. In contrast to this, in the first embodiment, in the shut-off valve 21, the first filter member 21-8 is provided in the flow path between the valve seat 21-6f and the second communication bore 21-7e. It should be noted that the SOL/V IN 22, the communication valve 23, the pressure-regulating valve 24, the SS/V IN 27, and the SS/V OUT 28 are also arranged in the same way as the shut-off valve 21. Thus, it is possible to suppress an increase in size in the axial direction and to attain a reduction in size of the second unit 1B. The size reduction of the second unit 1B makes it possible to improve the vehicle mountability of the brake apparatus 1.

The first embodiment provides the following advantages.

(1) An electromagnetic valve 21 (22, 23, 24, 27, 28) includes a coil 21 (22, 23, 24, 27, 28)-1 configured to generate electromagnetic force when energized, a cylinder 21 (22, 23, 24, 27, 28)-2 of a non-magnetic material disposed at the inner periphery of the coil 21 (22, 23, 24, 27, 28)-1, a plunger 21 (22, 24)-4/armature 23(27, 28)-4 configured to move in the cylinder 21 (22, 23, 24, 27, 28)-2 along an axial direction of the cylinder 21 (22, 23, 24, 27, 28)-2 by using the electromagnetic force generated by the coil 21 (22, 23, 24, 27, 28)-1, a flow path 21 (22, 23, 24, 27, 28)-13, a first communication bore 21 (22, 23, 24, 27, 28)-6e formed at one end of the now path 21 (22, 23, 24, 27, 28)-13, a valve seat 21 (22, 23, 24, 27, 28)-6f which is formed around the first communication bore 21 (22, 23, 24, 27, 28)-6e and against which the plunger 21 (22, 24)-4/armature 23(27, 28)-4 abuts to close the first communication bore 21 (22, 23, 24, 27, 28)-6e, a second communication bore 21 (22, 23, 24, 27, 28)-7e formed at the other end of the flow path 21 (22, 23, 24, 27, 28)-13, and a first filter member 21 (22, 23, 24, 27, 28)-8 provided in the flow path 21 (22, 23, 24, 27, 28)-13 to filter a brake fluid flowing between the first communication bore 21 (22, 23, 24, 27, 28)-6e and the second communication bore 21 (22, 23, 24, 27, 28)-7e.

Thus, the first filter member 21 (22, 23, 24, 27, 28)-8 is provided in the flow path 21 (22, 23, 24, 27, 28)-13 between the valve seat 21 (22, 23, 24, 27, 28)-6f and the second communication bore 21 (22, 23, 24, 27, 28)-7e. Therefore, the electromagnetic valve 21 (22, 23, 24, 27, 28) can be suppressed from increasing in size in the axial direction.

(2) The electromagnetic valve 21 (22, 23, 24, 27 28) described in (1) further includes a seat member 21 (22, 23, 24, 27, 28)-6 having the first communication bore 21 (22, 23, 24, 27, 28)-6e in a bottom portion 21 (22, 23, 24, 27, 28)-6a thereof, and a body member 21 (22, 23, 24, 27, 28)-7 fitted to an opening side of the seat member 21 (22, 23, 24, 27, 28)-6 and having the second communication bore 21 (22, 23, 24, 27, 28)-7e in a bottom portion 21 (22, 23, 24, 27, 28)-6a thereof. The flow path 21 (22, 23, 24, 27, 28)-13 is a space formed between the seat member 21 (22, 23, 24, 27, 28)-6 and the body member 21 (22, 23, 24, 27, 28)-7.

Thus, the first filter member 21 (22, 23, 24, 27, 28)-8 is provided in the space between the seat member 21 (22, 23, 24, 27, 28)-6 and the body member 21 (22, 23, 24, 27, 28)-7. Therefore, the electromagnetic valve 21 (22, 23, 24, 27, 28) can be suppressed from increasing in size in the axial direction.

(3) In the electromagnetic valve 21 (22, 23, 24, 27, 28) described in (2), a cylindrical wall of the body member 21 (22, 23, 24, 27, 28)-7 includes, in an inner peripheral surface thereof, an inner abutment surface 21 (22, 23, 24, 27, 28)-7g abutting against an outer peripheral surface 21-6g of a cylindrical wall of the seat member 21 (22, 23, 24, 27, 28)-6, and a flow bore 21 (22, 23, 24, 27, 28)-7f formed closer to the opening side than the inner abutment surface 21 (22, 23, 24, 27, 28)-7g to form an oil passage communicating with the first communication bore 21 (22, 23, 24, 27, 28)-6e. The electromagnetic valve 21 (22, 23, 24, 27, 28) further includes a second filter member 21 (22, 23, 24, 27, 28)-9 provided at an outer periphery side of the body member 21 (22, 23, 24, 27, 28)-7 to filter a brake fluid flowing into the flow bore 21 (22, 23, 24, 27, 28)-7f.

Accordingly, contamination flowing into the flow path 21 (22, 23, 24, 27, 28)-13 from the flow bore 21 (22, 23, 24, 27, 28)-7f can be suppressed by the second filter member 21 (22, 23, 24, 27, 28)-9.

(4) In the electromagnetic valve 21 (22, 23, 24, 27, 28) described in (3), the second filter member 21 (22, 23, 24, 27, 28)-9 is provided at a position outside the first filter member 21 (22, 23, 24, 27, 28)-8.

Thus, the first filter member 21 (22, 23, 24, 27, 28)-8 and the second filter member 21 (22, 23, 24, 27, 28)-9 overlap each other in the axial direction. Therefore, the electromagnetic valve 21 (22, 23, 24, 27, 28) can be suppressed from increasing in size in the axial direction.

(5) In the electromagnetic valve 21 (22, 23, 24, 27, 28) described in (2), the seat member 21 (22, 23, 24, 27, 28)-6 includes a large-diameter portion 21 (22, 23, 24, 27, 28)-6c formed at an opening side thereof. The large-diameter portion 21 (22, 23, 24, 27, 28)-6c has a diameter larger than that of a bottom side of the seat member 21 (22, 23, 24, 27, 28 )-6. The large-diameter portion 21 (22, 23, 24, 27, 28)-6c is enlarged in diameter relative to the bottom portion 21 (22, 23, 24, 27, 28)-6a of the seat member 21 (22, 23, 24, 27, 28)-6 via a first step portion 21 (22, 23, 24, 27, 28)-6d. The body member 21 (22, 23, 24, 27, 28)-7 includes a small-diameter portion 21 (22, 23, 24, 27, 28)-7b formed at a bottom side thereof. The small-diameter portion 21 (22, 23, 24, 27, 28)-7b has a diameter smaller than that of an opening side of the body member 21 (22, 23, 24, 27, 28)-7. The small-diameter portion 21 (22, 23, 24, 27, 28)-7b is reduced in diameter relative to the opening portion of the body member 21 (22, 23, 24, 27, 28)-7 via a second step portion 21 (22, 23, 24, 27, 28)-7d. The space 21 (22, 23, 24 27, 28)-13 is formed between the first step portion 21 (22, 23, 24, 27, 28)-6d and the second step portion 21 (22, 23, 24, 27, 28)-7d, and the first filter member 21 (22, 23, 24, 27, 28)-8 is engaged with the first step portion 21 (22, 23, 24, 27, 28)-6d and the second step portion 21 (22, 23, 24, 27, 28)-7d in the axial direction.

Accordingly, the first filter member 21 (22, 23, 24, 27, 28)-8 can be easily held by using the first step portion 21 (22, 23, 24, 27, 28)-6d and the second step portion 21 (22, 23, 24, 27, 28)-7d, which are disposed to face each other.

(6) In the electromagnetic valve 21 (22, 23, 24, 27, 28) described in (5), the space 21 (22, 23, 24, 27, 28)-13 is formed by abutting an outer peripheral surface 21-6g of an annular cylindrical wall of the seat member 21 (22, 23, 24, 27, 28)-6 against an inner peripheral surface 21 (22, 23, 24, 27, 28)-7g of an annular cylindrical wall of the body member 21 (22, 23, 24, 27, 28)-7. The first filter member 21 (22, 23, 24, 27, 28)-8 is provided to face an inner peripheral surface 21 (22, 23, 24, 27, 28)-6h of the cylindrical wall of the seat member 21 (22, 23, 24, 27, 28)-6.

Accordingly, the space 21 (22, 23, 24, 27, 28)-13 can be easily formed simply by superimposing the seat member 21 (22, 23, 24, 27, 28)-6 and the both member 21 (22, 23, 24, 27, 28)-7 to each other. Further, assembleability can be improved because the first filter member 21 (22, 23, 24, 27, 28)-8 can be assembled in the space 21 (22, 23, 24, 27, 28)-13 simply by fitting the first filter member 21 (22, 23, 24, 27, 28)-8 into the seat member 21 (22, 23, 24, 27, 28)-6.

(7) In the electromagnetic valve 21 (22, 23, 24, 27, 28) described in (6), the first filter member 21 (22, 23, 24 27, 28)-8 includes a mesh portion 21-8a and an annular frame body 21-8b provided at the outer periphery of the mesh portion 21-8a. A clearance smaller than the mesh size of the mesh portion 21-8a is formed between the inner peripheral surface 21 (22, 23, 24, 27, 28)-6h of the cylindrical wall of the seat member 21 (22, 23, 24, 27, 28)-6 and an outer peripheral surface 21-8c of the frame body 21-8b.

Thus, the first filter member 21 (22, 23, 24, 27, 28)-8 can be assembled to the seat member 21 (22, 23, 24, 27, 28)-6 simply by fitting the frame body 21-8b into the seat member 21 (22, 23, 24, 27, 28)-6. Therefore, assembleability can be improved, and it is possible to suppress the inflow of contamination through the clearance between the seat member 21 (22, 23, 24, 27, 28)-6 and the frame body 21-8b.

(8) In the electromagnetic valve 21 (22, 23, 24, 27, 28) described in (7), the frame body 21-8b is held between the inner peripheral surface 21, (22, 23, 24, 27, 28)-6h of the seat member 21 (22, 23, 24, 27, 28)-6 and the inner peripheral surface 21 (22, 23, 24, 27, 28)-7g of the body member 21 (22, 23, 24, 27, 28)-7 in the axial direction.

Accordingly, the first filter member 21 (22, 23, 24, 27, 28)-8 can be positioned simply by fitting the seat member 21 (22, 23, 24, 27, 28)-6 into the body member 21 (22, 23, 24, 27, 28)-7. Therefore, it is possible to easily perform positioning of the first filter member 21 (22, 23, 24, 27, 28)-8.

(9) In the electromagnetic valve 21 (22, 23, 24, 27, 28) described in (2), the body member 21 (22, 23, 24, 27, 28)-7 includes a small-diameter portion 21 (22, 23, 24, 27, 28)-7b formed at a bottom side thereof and having a diameter smaller than that of an opening side of the body member 21 (22, 23, 24, 27, 28)-7. A seal member 21 (22, 23, 24, 27, 28)-10 that seals between the small-diameter portion 21 (22, 23, 24, 27, 28)-7b and a housing (another member) 8 is fitted around an outer periphery of the small-diameter portion 21 (22, 23, 24, 27, 28)-7b.

Accordingly, the seal member 21 (22, 23, 24, 27, 28)-10 can be easily fitted using the small-diameter portion 21 (22, 23, 24, 27, 28)-7b,

(10) The electromagnetic valve 23 (27, 28) described in (2) further includes a body center 23 (27, 28)-3 secured to one end side of the cylinder 23 (27, 28)-2, and a coil spring 23 (27, 28)-12 compressedly interposed between the body center 23 (27, 28)-3 and the other end of the armature 23(27, 28)-4 in the cylinder 23 (27, 2)-2 to bias the armature 23(27, 28)-4 toward the valve seat 23 (27, 28)-6f. The armature 23(27, 28)-4 is attracted toward the body center 23 (27, 28)3 by electromagnetic force generated by the coil 23-1.

Accordingly, the normally-closed electromagnetic valve 23 (27, 28) can be suppressed from increasing in size in the axial direction.

(11) The electromagnetic valve 21 (22, 24) described in (2) further includes an armature 21 (22, 24)-3 axially movably provided in the cylinder 21 (22, 24)-2, and a coil spring 21 (22, 24)-12 configured to bias the plunger 21 (22, 24)-4 toward the armature 21(22, 24)-3 in the cylinder 21 (22, 24)-2. The plunger 21 (22, 24)-4 is moved together with the armature 21(22, 24)-3 toward the valve seat 21 (22, 24)-6f by electromagnetic force generated by the coil 21 (22, 24)-1.

Accordingly, the normally-open electromagnetic valve 21 (22, 24) can be suppressed from increasing in size in the axial direction.

(12) In the electromagnetic valve 21 (22, 24) described in (11), the cylinder 21 (22, 24)-2 is closed at one end thereof and open at the other end thereof. The electromagnetic valve 21 (22, 24) further includes a first accommodating bore 21 (22, 24)-5d which is provided at the other end side of the cylinder 21 (22, 24)-2 and in which the plunger 21 (22, 24)-4 is axially movably inserted. Further, the electromagnetic valve 21 (22, 24) includes a retaining portion 21 (22, 24)-5f formed on an inner peripheral surface of the first accommodating bore 21 (22, 24)-5d, and a large-diameter portion 21 (22, 24)-4a which is formed at one end side of the plunger 21 (22, 24)-4, and is larger in diameter than the other end side of the plunger 21 (22, 24)-4. The coil spring 21 (22, 24)-12 is compressedly interposed between the retaining portion 211 (22, 24)-5f and the large-diameter portion 21 (22, 24)-4a.

Accordingly, the normally-open electromagnetic valve 21 (22, 24) can be suppressed from increasing in size in the axial direction.

(13) A second unit 1B includes an electromagnetic valve 21 ( 22, 23, 24, 27, 28). The electromagnetic valve 21 (22, 23, 24, 27, 28) includes a housing 8 having an oil passage therein, a valve accommodating bore 841 (842, 843, 844, 847, 848) opening on one side surface of the housing 8 and connected to the oil passage, a coil 21 (22, 23, 24, 27, 28)-1 disposed at the housing 8 at a position along an axial direction of the valve accommodating bore 841 (842, 843, 844, 847, 848) to generate electromagnetic force when energized, a cylinder 21 (22, 23, 24, 27, 28)-2 of a non-magnetic material disposed at the inner periphery of the coil 21 (22, 23, 24, 27, 28)-1, a plunger 21 (22, 24)-4/armature 23(27, 28)-4 configured to move in the cylinder 21 (22, 23, 24, 27, 28)-2 along an axial direction of the cylinder 21 (22, 23, 24, 27, 28)-2 by using the electromagnetic force generated by the coil 21 (22, 23, 24, 27, 28)-1, a bottomed seat member 21 (22, 23, 24, 27, 28)-6 including a first communication bore 21 (22, 23, 24, 27, 28)-6e formed in a bottom portion 21 (22, 23 24, 27, 28)-6a thereof and a valve seat 21 (22, 23, 24, 27, 28)-6f against which the plunger 21 (22, 24)-4/armature 23(27, 28)-4 abuts to close the first communication bore 21 (22, 23, 24, 27, 28)-6e, a bottomed body member 21 (22, 23, 24, 27, 28)-7 secured in the valve accommodating bore 841 (842, 843, 844, 847, 848) and having a second communication bore 21 (22, 23, 24, 27, 28)-7e formed in a bottom portion 21 (22, 23, 24, 27, 28)-7a thereof, an internal oil passage 21 (22, 23, 24, 27, 28)-13 formed by fitting an opening side of the seat member 21 (22, 23, 24, 27, 28)-6 and an opening side of the body member 21 (22, 23, 24, 27, 28)-7 to each other, and a first filter member 21 (22, 23, 24, 27, 28)-8 provided in the internal oil passaue 21 (22, 23, 24, 27, 28)-13.

Thus, the first filter member 21 (22, 23, 24, 27, 28)-8 is provided in the flow path 21 (22, 23, 24, 27, 28)-13. Therefore, the electromagnetic valve 21 (22, 23, 24, 27, 28) can be suppressed from increasing in size in the axial direction, and the second unit 1B can be reduced in size.

(14) In the second unit 1B described in (13), a cylindrical wall of the body member 21 (22, 23, 24, 27, 28)-7 includes on an inner peripheral surface thereof an inner abutment surface 21 (22, 23, 24, 27, 28)-7g abutting against an outer peripheral surface 21(22, 23, 24, 27, 28)-6g of a cylindrical wall of the seat member 21 (22, 23, 24, 27, 28)-6, and a flow bore 21 (22, 23, 24, 27 28)-7f formed closer to the opening side than the inner abutment surface 21 (22, 23, 24, 27, 28)-7g and forming an oil passage communicating with the first communication bore 21 (22, 23, 24, 27, 28)-6e. A second filter member 21 (22, 23, 24, 27, 28)-9 configured to filter a brake fluid flowing into the flow bore 21 (22, 23, 24, 27, 28)-7f is provided on the outer peripheral side of the body member 21 (22, 23, 24, 27, 28)-7.

Accordingly, contamination flowing into the flow path 21 (22, 23, 24, 27, 28)-13 from the flow bore 21 (22, 23, 24, 27, 28)-7f can be suppressed by the second filter member 21 (22, 23, 24, 27, 28)-9.

(15) In the second unit 1B described in (14), the second filter member 21 (22, 23, 24, 27, 28)-9 is provided at a position outside the first filter member 21 (22, 23, 24, 27, 28)-8.

Thus, the first filter member 21 (22, 23, 24, 27, 28)-8 and the second filter member 21 (22, 23, 24, 27, 28)-9 overlap each other in the axial direction. Therefore, the electromagnetic valve 21 (22, 23, 24, 27, 28) can be suppressed from increasing in size in the axial direction.

(16) A brake apparatus 1 includes a plurality of electromagnetic valves 21 (22, 23, 24, 27, 28). The plurality of electromagnetic valves 21 (22, 23, 24, 27, 28) includes a housing 8 having an oil passage therein, a plurality of valve accommodating bores 841 (842, 843, 844, 847, 848) opening on one side surface of the housing 8 and connected to the oil passage, a coil 21 (22, 23 24, 27, 28)-1 disposed at the housing 8 at a position along an axial direction of each valve accommodating bore 841 (842, 843, 844, 847, 848) and configured to generate electromagnetic force when energized, a cylinder 21 (22, 23, 24, 27, 28)-2 of a non-magnetic material disposed at an inner periphery of the coil 21 (22, 23, 24, 27, 28)-1, a plunger 21 (22, 24)-4/armature 23(27, 28)-4 configured to move in the cylinder 21 (22, 23, 24, 27, 28)-2 along an axial direction of the cylinder 21 (22, 23, 24, 27, 28)-2 by using electromagnetic force generated by the coil 21 (22, 23, 24, 27, 28)-1, a seat member 21 (22, 23, 24, 27, 28)-6 including a first communication bore 21 (22, 23, 24, 27, 28)-6e formed in a bottom portion 21 (22, 23, 24, 27, 28)-6a thereof and a valve seat 21 (22, 23, 24, 27, 28)-6f against which the plunger 21 (22, 24)-4/armature 23(27, 28)-4 abuts to close the first communication bore 21 (22, 23, 24, 27, 28)-6e, a body member 21 (22, 23, 24, 27, 28)-7 secured in the associated one of the valve accommodating bores 841 (842, 843, 844, 847, 848) and having a second communication bore 21 (22, 23, 24, 27, 28)-7e formed in a bottom portion 21 (22, 23, 24, 27, 28)-7a thereof, an internal space 21 (22, 23, 24, 27, 28)-13 which is surrounded by the seat member 21 (22, 23, 24, 27, 28)-6 and the body member 21 (22, 23, 24, 27, 28)-7 and through which a brake fluid flows, and a first filter member 21 (22, 23, 24, 27, 28)-8 provided in the internal space 21 (22, 23, 24, 27, 28)-13.

Thus, the first filter member 21 (22, 23, 24, 27, 28)-8 is provided in the flow path 21 (22, 23, 24, 27, 28)-13. Therefore, each of the electromagnetic valves 21 (22, 23, 24, 27, 28) can be suppressed from increasing in size in the axial direction. Accordingly, the brake apparatus 1 can be reduced in size and improved in vehicle mountability.

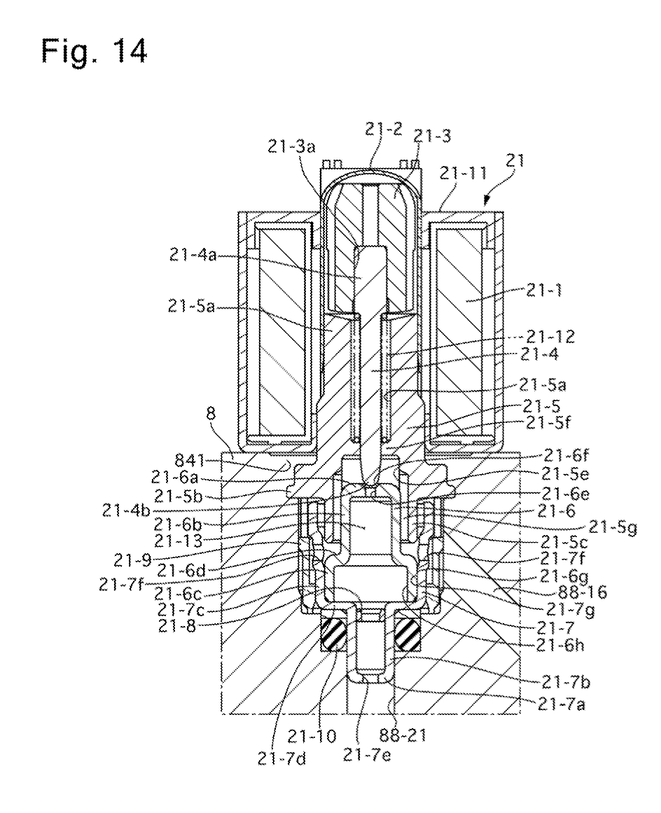

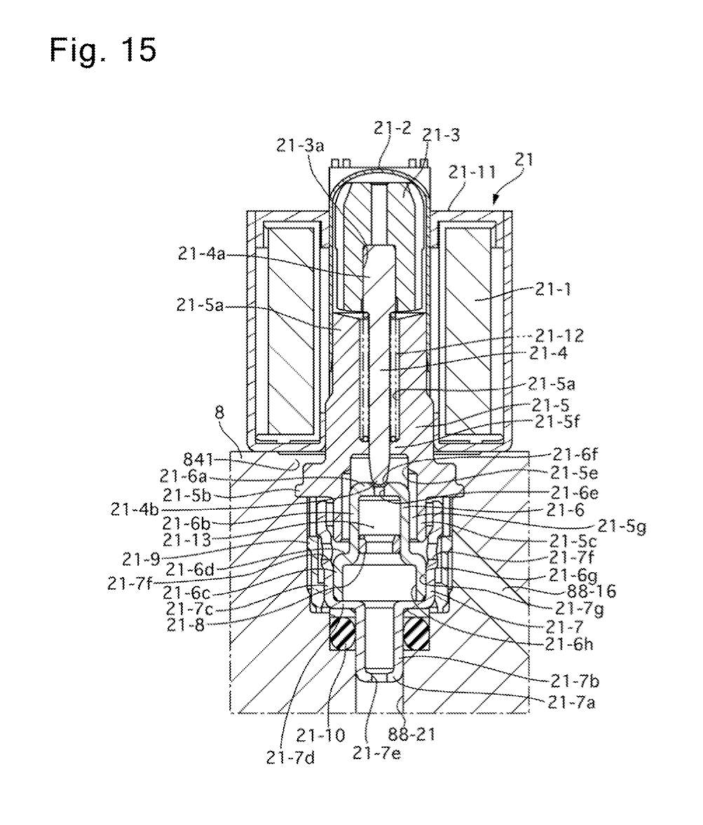

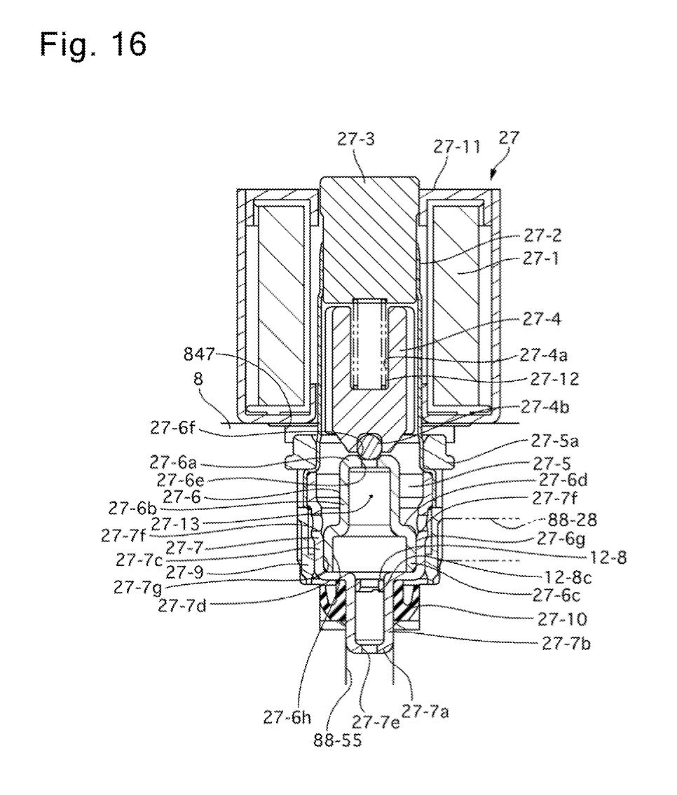

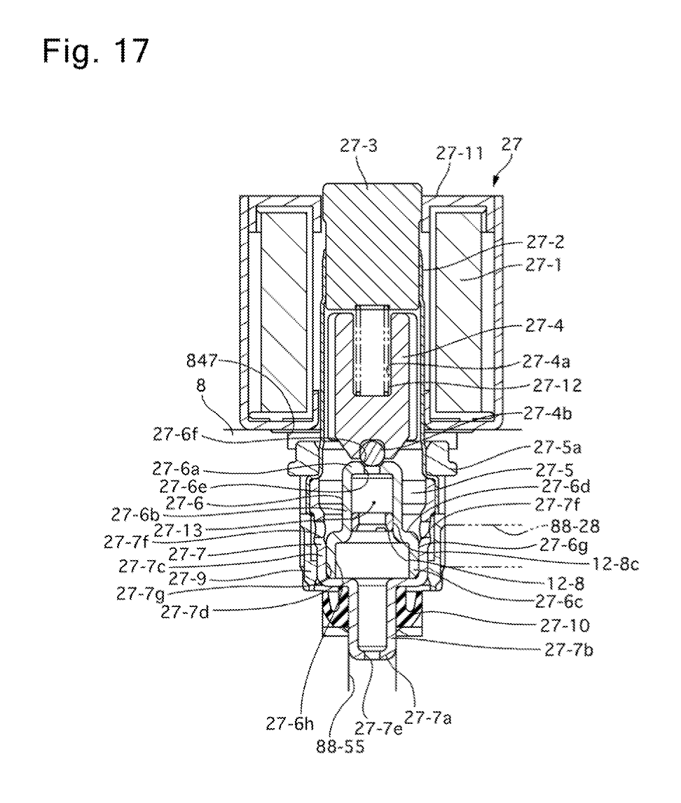

Although the mode for carrying out the present invention has been explained above on the basis of the embodiments, the specific structure of the present invention is not limited to the embodiments. The present invention includes changes in design or other changes made without departing from the gist of the invention. In addition, the structural elements described in the claims and the specification can be arbitrarily combined or omitted within a range in which the above-mentioned problems are at least partially solved, or within a range in which at least a part of the above-mentioned advantages is achieved. For example, the first filter member may be disposed at any position in a space formed between the seat member and the body member (i.e. an internal oil passage formed by fitting the opening side of the seat member and the opening side of the body member to each other). For example, in the shut-off valve 21 in FIG. 14, the first filter member 21-8 is fitted to the small-diameter portion 21-7b of the body member 21-7. In the shut-off valve 21 in FIG. 15, on the other hand, the first filter member 21-8 is fitted to the small-diameter portion 21-6b of the seat member 21-6. These structures are also applicable to the normally-closed electromagnetic valves. In the SS/V IN 27 in FIG. 16, the filter member 27-8 is fitted to the small-diameter portion 27-7b of the body member 27-7. In the SS/V IN 27 in FIG. 17, on the other hand, the first filter member 27-8 is fitted to the small-diameter portion 27-6b of the seat member 27-6.

The present application claims priority to Japanese Patent Application No. 2015-176636 filed on Sep. 8, 2015. The entire disclosure of Japanese Patent Application No. 2015-176636 filed on Sep. 8, 2015 including the specification, the claims, the drawings and the summary is incorporated herein by reference in its entirety.

### REFERENCE SIGNS LIST

8: housing; 841, 842, 843, 844, 847, 848: valve accommodating bore (installation bore); 21 (22, 23, 24, 27, 28)-1: coil 21 (22, 23, 24, 27, 28)-2; cylinder; 21 (22, 24)-3: armature (movable iron core); 23 (27, 28)-3: body center (fixed iron core); 21 (22, 24)-4: plunger (valve element); 23(27, 28)-4: armature (valve element, movable iron core); 21 (22, 24)-5: valve body; 23 (27, 28)-5: flange ring; 21 (22, 23, 24, 27, 28)-6: seat member; 21 (22, 23, 24, 27, 28)-6e: first communication bore; 21 (22, 23, 24, 27, 28)-6f; valve seat; 21 (22, 23, 24, 27, 28)-7: body member; 21 (22, 23, 24, 27, 28)-7e: second communication bore; 21 (22, 23, 24, 27, 28)-8: first filter member (filter member); 21 (22, 23, 24, 27, 28)-9: second filter member; 21 (22, 23, 24, 27, 28)-10: seal member; 21(22, 23, 24, 27, 28)-11: yoke; 21 (22, 23, 24, 27, 28)-12: coil spring (resilient member); 21(22, 23, 24, 27, 28)-13: flow path (internal oil passage, internal space).

1. An electromagnetic valve comprising:
a coil configured to generate electromagnetic force when energized;
a cylinder disposed at an inner periphery of the coil, and formed of a non-magnetic material;
a valve element configured to move in the cylinder along an axial direction of the cylinder by using the electromagnetic force generated by the coil;
a flow path;
a first communication bore formed at one end of the flow path;
a valve seat formed around the first communication bore, and configured to close the first communication bore by an abutment with the valve element;
a second communication bore formed at an opposite end of the flow path; and
a first filter member provided in the flow path and configured to filter a fluid flowing between the first communication bore and the second communication bore.

2. The electromagnetic valve of claim 1, further comprising:
a seat member including a bottom portion formed with the first communication bore; and
a body member which includes a bottom portion formed with the second communication bore, and which is fitted to an opening side of the seat member,
wherein the flow path is a space formed between the seat member and the body member.

3. The electromagnetic valve of claim 2, wherein a cylindrical wall of the body member includes an inner peripheral surface,
the inner peripheral surface includes an inner abutment surface abutting against an outer peripheral surface of a cylindrical wall of the seat member, and a flow bore formed closer to an opening side than the inner abutment surface and forming an oil passage communicating with the first communication bore, and
a second filter member configured to filter the fluid flowing into the flow bore is provided at an outer periphery side of the body member.

4. The electromagnetic valve of claim 3, wherein the second filter member is provided at a position outside the first filter member.

5. The electromagnetic valve of claim 2, wherein the seat member includes a large-diameter portion formed at an opening side thereof, having a diameter larger than that of a bottom side of the seat member, and enlarged in diameter relative to a bottom portion of the seat member via a first step portion,
the body member includes a small-diameter portion formed at a bottom side thereof, having a diameter smaller than that of an opening side of the body member, and reduced in diameter relative to an opening portion of the body member via a second step portion,
the space is formed between the first step portion and the second step portion, and
the first filter member is engaged with at least one of the first step portion or the second step portion.

6. The electromagnetic valve of claim 5, wherein the space is formed by an abutment of an outer peripheral surface of an annular cylindrical wall of the seat member against an inner peripheral surface of an annular cylindrical wall of the body member, and
the first filter member is provided to face an inner peripheral surface of the cylindrical wall of the seat member.

7. The electromagnetic valve of claim 6, wherein the first filter member includes a mesh portion and an annular frame body provided around an outer periphery of the mesh portion, and
a clearance smaller than a mesh size of the mesh portion is formed between the inner peripheral surface of the cylindrical wall of the seat member and an outer peripheral surface of the frame body.

8. The electromagnetic valve of claim 7, wherein the frame body is held between the inner peripheral surface of the seat member and the inner peripheral surface of the body member in an axial direction.

9. The electromagnetic valve of claim 2, wherein the body member includes a small-diameter portion formed at a bottom side thereof, and having a diameter smaller than that of an opening side of the both member, and
a seal member configured to seal between the small-diameter potion and another member is fitted around an outer periphery of the small-diameter portion.

10. The electromagnetic valve of claim 2, further comprising:
a fixed iron core secured to one end side of the cylinder; and
a resilient member compressedly interposed between the fixed iron core and the valve element in the cylinder, and configured to bias the valve element toward the valve seat,
wherein the valve element is attracted toward the fixed iron core by the electromagnetic force generated by the coil.

11. The electromagnetic valve of claim 2, further comprising:
a movable iron core axially movably provided in the cylinder; and
a resilient member configured to bias the valve element toward the movable iron core in the cylinder,
wherein the valve element is moved together with the movable iron core toward the valve seat by the electromagnetic force generated by the coil.

12. The electromagnetic valve of claim 11, wherein the cylinder includes one end which is closed and an opposite end which is open,
the electromagnetic valve further comprising:
an insertion bore which is provided at the opposite end side of the cylinder and in which the valve element is axially movably inserted;
a retaining portion formed on an inner peripheral surface of the insertion bore; and
a large-diameter portion which is formed at one end side of the valve element, and is larger in diameter than an opposite end side of the valve element, and
wherein the resilient member is compressedly interposed between the retaining portion and the large-diameter portion.

13. A fluid pressure control device comprising:
an electromagnetic valve, and
the electromagnetic valve including:
a housing having an oil passage therein;
a bore opening on one side surface of the housing and connected to the oil passage;
a coil disposed at the housing at a position along an axial direction of the bore, and configured to generate electromagnetic force when energized;
a cylinder disposed at an inner periphery of the coil, and formed of a non-magnetic material;
a valve element configured to move in the cylinder along an axial direction of the cylinder by using the electromagnetic force generated by the coil;
a bottomed seat member including a bottom portion formed with a first communication bore and a valve seat configured to close the first communication bore by an abutment with the valve element;
a bottomed body member including a bottom portion formed with a second communication bore, and secured in the bore;
an internal oil passage formed by fitting an opening side of the seat member and an opening side of the body member to each other; and
a first filter member provided in the internal oil passage.

14. The fluid pressure control device of claim 13, wherein a cylindrical wall of the body member includes an inner peripheral surface,
the inner peripheral surface includes an inner abutment surface abutting against an outer peripheral surface of a cylindrical wall of the seat member, and a flow bore formed closer to an opening side than the inner abutment surface and forming an oil passage communicating with the first communication bore, and
a second filter member configured to filter a fluid flowing into the flow bore is provided at an outer periphery side of the body member.

15. The fluid pressure control device of claim 14, wherein the second filter member is provided at a position outside the first filter member.

16. The fluid pressure control device of claim 13, comprising as the electromagnetic valve:
a normally-closed electromagnetic valve including a fixed iron core secured to one end side of the cylinder, and a resilient member compressedly interposed between the fixed iron core and the valve element in the cylinder and configured to bias the valve element toward the valve seat, the valve element being attracted toward the fixed iron core by the electromagnetic force generated by the coil; and
a normally-open electromagnetic valve including a movable iron core axially movably provided in the cylinder, and a resilient member biasing the valve element toward the movable iron core in the cylinder, the valve element being moved together with the movable iron core toward the valve seat by the electromagnetic force generated by the coil.

17. The fluid pressure control device of claim 13, wherein the body member includes a small-diameter portion formed at a bottom side thereof, and having a diameter smaller than that of an opening side of the body member, and
a seal member configured to seal between the small-diameter portion and another member is fitted around an outer periphery of the small-diameter portion.

18. The fluid pressure control device of claim 17, wherein the seat member includes a large-diameter portion formed at an opening side thereof, having a diameter larger than that of a bottom side of the seat member, and enlarged in diameter relative to a bottom portion of the seat member via a first step portion,
the body member includes a small-diameter portion formed at a bottom side thereof, having a diameter smaller than that of an opening side of the body member, and reduced in diameter relative to an opening portion of the body member via a second step portion,
the internal oil passage is formed between the first step portion and the second step portion, and
the first filter member is engaged with at least one of the first step portion or the second step portion.

19. The fluid pressure control device of claim 18, wherein the internal oil passage is formed by an abutment of an outer peripheral surface of an annular cylindrical wall of the seat member against an inner peripheral surface of an annular cylindrical wall of the body member, and
the first filter member is provided to face an inner peripheral surface of the cylindrical wall of the seat member.

20. A brake apparatus comprising:
a plurality of electromagnetic valves, and
the electromagnetic valves including:
a housing having an oil passage therein;
a plurality of installation bores opening on one side surface of the housing and connected to the oil passage;
a coil disposed at the housing at a position along an axial direction of each of the installation bores, and configured to generate electromagnetic force when energized;
a cylinder disposed at an inner periphery of the coil, and formed of a non-magnetic material;
a valve element configured to move in the cylinder along an axial direction of the cylinder by using the electromagnetic force generated by the coil;
a seat member including a bottom portion formed with a first communication bore, and a valve seat configured to close the first communication bore by an abutment with the valve element;
a body member including a bottom portion formed with a second communication bore, and secured in an associated one of the installation bores;
an internal space which is surrounded by the seat member and the body member and through which a brake fluid flows; and
a filter member provided in the internal space.
